(19) United States
(12) Patent Application Publication
(10) Pub. No.: US 2025/0350412 A1
(43) Pub. Date: Nov. 13, 2025

(54) SYSTEMS, APPARATUSES, METHODS, AND NON-TRANSITORY COMPUTER-READABLE STORAGE MEDIA FOR WIRELESS COMMUNICATION EMPLOYING DISTRIBUTIVE RESOURCE UNITS WITH IMPROVED POWER DISTRIBUTION

(71) Applicant: HUAWEI TECHNOLOGIES CO., LTD., Shenzhen (CN)

(72) Inventors: Yan Xin, Kanata (CA); Jung Hoon Suh, Kanata (CA); Osama Aboul-Magd, Kanata (CA); Sara Norouzi, Vancouver (CA)

(21) Appl. No.: 18/987,400

(22) Filed: Dec. 19, 2024

Related U.S. Application Data
(60) Provisional application No. 63/645,064, filed on May 9, 2024.

(51) Int. Cl. H04L 5/00; H04L 1/1607

(52) U.S. Cl. CPC H04L 5/0007; H04L 1/1607; H04L 5/0055; H04L 5/0098

(57) ABSTRACT

A communication method has the step of: transmitting or receiving a signal using a first resource unit (RU) in an orthogonal frequency-division multiple access (OFDMA) physical layer protocol data unit (PPDU) having a plurality of subcarriers, some of which are available subcarriers for transmitting data and/or pilot symbols, and others are unavailable subcarriers. The first RU is one of a plurality of RUs of the OFDMA PPDU. Each RU has a subset of the available subcarriers. The subcarrier indices of any one of the RUs are different from the subcarrier indices of any other one of the RUs, and the subcarriers of each of the RUs are substantially distributed over an entirety of a frequency spectrum formed by all the available subcarriers. The unavailable subcarriers include predefined unavailable subcarriers and subcarriers that are in an unallocated or punctured frequency spectrum.

### CROSS-REFERENCE TO RELATED APPLICATION

This application claims the benefit of U.S. Provisional Patent Application Ser. No. 63/645,064, filed May 9, 2024, the content of which is incorporated herein by reference in its entirety.

### FIELD OF THE DISCLOSURE

The present disclosure relates generally to communication systems, apparatuses, methods, and non-transitory computer-readable storage media, and in particular to systems, apparatuses, methods, and non-transitory computer-readable storage media for wireless communication employing distributive resource units with improved power distribution.

### BACKGROUND

Wireless communication systems such as IEEE 802.11ac (WI-FI® 5; WI-FI is a registered trademark of Wi-Fi Alliance, Austin, TX, USA) and IEEE 802.11ax (WI-FI® 6) systems need to meet the govern-regulated power spectral density (PSD) requirements, which lays the limit in the upper bound on the transmitter (TX) power at, for example, every one (1) megahertz (MHz). The total TX power has also been regulated.

In wireless communication systems (such as IEEE 802.11ax (WI-FI® 6) systems) using orthogonal frequency division multiple access (OFDMA; which uses orthogonal frequency division multiplexing (OFDM) for multiple access), the resource unit (RU) is the OFDMA scheduling unit. In conventional wireless communication technologies, a RU usually only occupies a sub-bandwidth of consecutive subcarriers of the OFDM frame according to the size of the RU. When using OFDMA, different RUs may be used with different TX power. However, the government-regulated PSD requirements limit the TX power that can be used in RUs.

### SUMMARY

According to one aspect of this disclosure, there is provided a first communication method comprising: transmitting or receiving a signal to a device using a first resource unit (RU) in an orthogonal frequency-division multiple access (OFDMA) physical layer protocol data unit (PPDU) having a plurality of subcarriers for transmitting data, pilot symbols, or a combination thereof; wherein a subset of the subcarriers are unavailable for use, thereby giving rise to a plurality of available subcarriers being the plurality of subcarriers excluding the subset of unavailable subcarriers; wherein the first RU is one of a plurality of RUs of the OFDMA PPDU; wherein each RU comprises a subset of the plurality of available subcarriers; and wherein, in each RU, each pair of neighboring subcarriers thereof are separated by a substantially same number of available subcarriers not belonging to the RU.

According to one aspect of this disclosure, there is provided a second communication method comprising: transmitting or receiving a signal using a first resource unit (RU) in an orthogonal frequency-division multiple access (OFDMA) physical layer protocol data unit (PPDU) having a plurality of subcarriers for transmitting data, pilot symbols, or a combination thereof; wherein a subset of the subcarriers are unavailable for use, thereby giving rise to a plurality of available subcarriers being the plurality of subcarriers excluding the subset of unavailable subcarriers; wherein the first RU is one of a plurality of RUs of the OFDMA PPDU; wherein each RU comprises a subset of the plurality of available subcarriers; wherein the subcarrier indices of any one of the plurality of RUs are different from the subcarrier indices of any other one of the plurality of RUs; and the subcarriers of each of the plurality of RUs are substantially distributed over an entirety of a frequency spectrum formed by all the available subcarriers; and wherein the subset of unavailable subcarriers comprise a plurality of predefined unavailable subcarriers and a plurality of unavailable subcarriers in an unallocated or punctured frequency spectrum.

In some embodiments, the subcarriers of each RU are same as those determined in accordance with a design method that shuffles the plurality of subcarriers; and the design method comprises: indexing the plurality of subcarriers to obtain an initial sequence comprising a plurality of consecutive first indices, the first indices comprising one or more index ranges corresponding to the unavailable subcarriers, indexing available subcarriers to obtain a first sequence comprising a plurality of consecutive second indices from a first end index to a second end index, the available subcarriers being the plurality of subcarriers excluding the subset of unavailable subcarriers, shuffling the first sequence to obtain a second sequence, comparing the second sequence with the initial sequence to determine if any of the second indices fall within the one or more index ranges, and if any of the second indices fall within one the one or more index ranges, updating the second sequence such that no second indices fall within the one or more index ranges, and determining the plurality of RUs based on a partitioning of the second sequence that partitions the second sequence into a plurality of consecutive blocks, each block corresponding to a respective one of the plurality of RUs.

In some embodiments, said updating the second sequence comprises: for each of the one or more index ranges that one or more of the second indices fall therewithin, updating the second sequence by adjusting, using a value, the indices from the one or more of the second indices to a predefined one of the first and second end indices, such that, after said updating the second sequence, no second indices fall within the one or more index ranges.

In some embodiments, said updating the second sequence comprises: for each of the one or more index ranges that one or more of the second indices fall therewithin, updating the second sequence by adding a respective value to the indices from the one or more of the second indices to a larger one of the first and second end indices, such that, after said updating the second sequence, no second indices fall within the one or more index ranges.

In some embodiments, said shuffling the first sequence to obtain the second sequence comprises: shuffling the first sequence to obtain the second sequence using a relative prime interleaving method.

In some embodiments, said shuffling the first sequence to obtain the second sequence using the relative prime interleaving method comprises: shuffling the first sequence {sₙ} to obtain the second sequence {sₖ′=sₖ₍ₙ₎}, where n=0, . . . , N−1 is an index of the first sequence, N is a length of the first sequence,

$$k ( n ) = ( p \cdot n ) mod N$$

for n=0, . . . , N−1, k is an index of the second sequence and is a function of n, mod represents a modulo function, and p is a distance between two neighboring subcarriers in each RU and is a relative prime of N such that p and N have no common factors other than one.

In some embodiments, p·max(Nⱼ)<N for j=1, . . . , J, where Nⱼ is a number of the subcarriers of the j-th RU, J is a number of the plurality of RUs, and max( ) represents a maximum function.

In some embodiments, said shuffling the first sequence to obtain the second sequence using the relative prime interleaving method comprises: shuffling the first sequence {sₙ} to obtain the second sequence {sₖ′=sₖ₍ₙ₎}, where n=0, . . . , N−1 is an index of the first sequence, N is a length of the first sequence,

$$k ( n ) = ( p \cdot n ) mod N$$

for n=0, . . . , N−1, k is an index of the second sequence and is a function of n, mod represents a modulo function, and p is a distance between two neighboring subcarriers in each RU and p and N have at least one common factor; and the design method further comprises a first set of steps or a second set of steps; wherein the first set of steps comprise: padding N_{pad} additional indices into the first sequence to expand the first sequence to (Nᵤ+N_{pad}) consecutive indices and updating N as Nᵤ+N_{pad}, where N_{pad}≥1 is a smallest integer that makes p a relative prime of the updated N, and Ny equals to the length of the first sequence before said padding, and after said shuffling the first sequence and before said partitioning the second sequence, removing the N_{pad} additional indices from the second sequence; and wherein the second set of steps comprise: removing Nₛₕₒᵣₜₑₙ indices from an end of the first sequence and updating N as Nᵤ−Nₛₕₒᵣₜₑₙ, where Nₛₕₒᵣₜₑₙ≥1 is a smallest integer that makes p a relative prime of the updated N, and Nᵤ equals to the length of the first sequence before said removing the Nₛₕₒᵣₜₑₙ indices, and after said shuffling the first sequence and before said partitioning the second sequence, adding the Nₛₕₒᵣₜₑₙ removed indices to the second sequence.

In some embodiments, p is a relative prime of (Nᵤ+N_{pad}), p≤┌(Nᵤ+N_{pad})/(max(Nⱼ))┐, j=1, . . . , J, and p≤┌(Nᵤ+N_{pad})/(Nⱼ+N_{pad})┐, where Nⱼ is a number of the subcarriers of the j-th RU, max( ) represents a maximum function, and ┌x┐ is function calculating a smallest integer that is greater than or equal to x.

In some embodiments, p is a relative prime of (Nᵤ−Nₛₕₒᵣₜₑₙ), and p≤┌(Nᵤ−Nₛₕₒᵣₜₑₙ)/(max(Nⱼ))┐, j=1, . . . , J, where Nⱼ is a number of the subcarriers of the j-th RU, max( ) represents a maximum function, and ┌x┐ is function calculating a smallest integer that is greater than or equal to x.

According to one aspect of this disclosure, there is provided an apparatus comprising: at least one processor; and one or more non-transitory computer-readable storage media functionally coupled to the at least one processor; wherein the one or more non-transitory computer-readable storage media comprising computer-executable instructions, wherein the instructions, when executed, cause the at least one processor to perform any of the above above-described methods.

According to one aspect of this disclosure, there is provided one or more non-transitory computer-readable storage devices or media comprising computer-executable instructions, wherein the instructions, when executed, cause one or more circuits, such as one or more processing units or one or more processors, to perform any of the above above-described methods.

According to one aspect of this disclosure, there is provided one or more circuits, such as one or more processing units or one or more processors, for performing any of the above above-described methods.

The methods, circuits, non-transitory computer-readable storage media, and systems disclosed herein provide a systematic way to distribute subcarriers (that is, tones) in multiple RUs (or more specifically denoted “distributed RUs (DRUs)”), each of which is for a specific station (STA), in an OFDMA PPDU by using relative prime interleaving to ensure the tones within each RU for different RU sizes and a variety of PPDU bandwidths to be substantially uniformly (that is, uniformly or nearly uniformly) distributed in order to avoid potential tone transmit power imbalance and significant different tone separations within one DRU and across DRUs. Existing 802.11ax/be RU locations and tone plan can be reused. The DRUs and their arrangements provide improved communication performance while meeting the government-regulated PSD requirements.

By using a (modified) relative prime interleaver, the DRU design methods disclosed herein provides ease of implementation and the flexibility that the indices in the interleaving/deinterleaving can be generated “on-the-fly” instead of using index mapping tables. This reduces the storage and memory in systems.

The DRU-design methods disclosed herein and the resulting DRU plans may be related to the standardization of next generation of IEEE 802.11be for operation on the unlicensed millimeter bands.

The DRU-design methods disclosed herein and the resulting DRU plans may be used in WI-FI APs and STAs with operating capability in both sub-7 GHz and millimeter bands.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing resource unit (RU) locations in a 20 MHz High Efficiency/Enhanced High Throughput (HE/EHT) physical layer protocol data unit (PPDU);

FIG. 5 is a schematic diagram showing RU locations in a 40 MHz HE/EHT PPDU;

FIG. 6 is a schematic diagram showing RU locations in an 80 MHz EHT PPDU;

FIGS. 7A and 7B are schematic diagrams showing regular RUs (RRUs) (FIG. 7A) and distributed RUs (DRUs) (FIG. 7B);

FIG. 8 is a table showing distributed RU (DRU) tone plan for distribution bandwidth 20 MHz;

FIG. 9 is a table showing distributed RU (DRU) tone plan for distribution bandwidth 40 MHz;

FIG. 10 is a table showing distributed RU (DRU) tone plan for distribution bandwidth 80 MHz;

FIG. 11 is a flowchart showing a DRU-design procedure using relative prime interleaving, according to some embodiments of this disclosure;

FIG. 12 is a flowchart showing the details of the DRU-design procedure shown in FIG. 11, according to some embodiments of this disclosure;

FIG. 13 is a schematic diagram showing an example of a PPDU having a plurality of RRUs;

FIG. 14A is a schematic diagram showing a first usable-tone sequence built from the PPDU shown in FIG. 13;

FIG. 14B is a schematic diagram showing a second usable-tone sequence obtained from relative prime interleaving of the first usable-tone sequence shown in FIG. 14A;

FIG. 15A is a schematic diagram showing the second usable-tone sequence shown in FIG. 14B after reordering;

FIG. 15B is a schematic diagram showing the PPDU after combining the DRUs in the second usable-tone sequence shown in FIG. 15A and a plurality of unusable tones;

FIG. 16 is a flowchart showing a DRU-design procedure using relative prime interleaving, according to some embodiments of this disclosure;

FIG. 17 is a schematic diagram showing a PPDU having a plurality of tones;

FIG. 18A is a schematic diagram showing a first usable-tone sequence built for the PPDU shown in FIG. 17;

FIG. 18B is a schematic diagram showing a second usable-tone sequence obtained from relative prime interleaving of the first usable-tone sequence shown in FIG. 18A;

FIG. 19A is a schematic diagram showing the second usable-tone sequence shown in FIG. 18B after reordering;

FIG. 19B is a schematic diagram showing the PPDU after combining the DRUs in the second usable-tone sequence shown in FIG. 19A and a plurality of unusable tones;

FIG. 20A is a schematic diagram showing an example of RRU partitioning for a 20 MHz OFDMA PPDU having 234 usable tones;

FIG. 20B is a schematic diagram showing an example of DRU partitioning for a 20 MHz OFDMA PPDU having 234 usable tones, obtained using the DRU-design procedure shown in FIG. 12 or 16;

FIG. 21A is a schematic diagram showing an example of RRU partitioning for a 40 MHz OFDMA PPDU having 468 usable tones;

FIG. 21B is a schematic diagram showing an example of DRU partitioning for a 40 MHz OFDMA PPDU having 468 usable tones, obtained using the DRU-design procedure shown in FIG. 12 or 16;

FIG. 22 is a flowchart showing a DRU-design procedure using relative prime interleaving with sequence padding, according to some embodiments of this disclosure;

FIG. 23 is a schematic diagram showing an example of dummy tone padding for the DRU-design procedure shown in FIG. 22;

FIG. 24 is a schematic diagram showing another example of dummy tone padding for the DRU-design procedure shown in FIG. 22;

FIG. 25 is a schematic diagram showing yet another example of dummy tone padding for the DRU-design procedure shown in FIG. 22;

FIG. 26 is a schematic diagram showing still another example of dummy tone padding for the DRU-design procedure shown in FIG. 22;

FIG. 27A is a schematic diagram showing an example of RRU partitioning for a 20 MHz OFDMA PPDU having 234 usable tones;

FIG. 27B is a schematic diagram showing an example of DRU partitioning for a 20 MHz OFDMA PPDU having 234 usable tones, obtained using the DRU-design procedure shown in FIG. 22;

FIG. 27C is a schematic diagram showing an example of DRU partitioning for a 20 MHz OFDMA PPDU having 234 usable tones, obtained from the DRU partitioning shown in FIG. 27B after reordering;

FIG. 28 is a schematic diagram showing the first and second usable-tone sequences obtained during the execution of the DRU-design procedure shown in FIG. 22, including the first usable-tone sequence with dummy tones padded to the end thereof, the second usable-tone sequence with dummy tones shuffled to various locations thereof, and the second usable-tone sequence after the dummy tones are removed;

FIG. 29A is a schematic diagram showing an example of a 20 MHz OFDMA PPDU having 234 usable tones partitioned into four (4) 52-tone RRUs, and one (1) 26-tone RRU at the center with two 52-tone RRUs on each side thereof;

FIG. 29B is a schematic diagram showing an example of the 20 MHz OFDMA PPDU having 234 usable tones partitioned into four (4) 52-tone DRUs and one (1) 26-tone DRU, obtained using the DRU-design procedure shown in FIG. 22, wherein the relative prime interleaver uses a tone separation of p=4;

FIG. 30A is a schematic diagram showing an example of a 20 MHz OFDMA PPDU having 238 usable tones partitioned into two (2) 106-tone RRUs, and one (1) 26-tone RRU at the center with one 106-tone RRUs on each side thereof;

FIG. 30B is a schematic diagram showing an example of the 20 MHz OFDMA PPDU having 238 usable tones partitioned into two (2) 106-tone DRUs and one (1) 26-tone DRU, obtained using the DRU-design procedure shown in FIG. 22, wherein the relative prime interleaver uses a tone separation of p=2;

FIG. 31A is a schematic diagram showing an example of a 40 MHz OFDMA PPDU having 468 usable tones partitioned into 18 RRUs each having 26 tones;

FIG. 31B is a schematic diagram showing an example of the 40 MHz OFDMA PPDU having 468 usable tones partitioned into 18 DRUs each having 26 tones, obtained using the DRU-design procedure 300 shown in FIG. 22, wherein the relative prime interleaver uses a tone separation of p=18;

FIG. 32A is a schematic diagram showing an example of a 40 MHz OFDMA PPDU having 468 usable tones partitioned into eight (8) RRUs each having 52 tones and two (2) RRUs each having 26 tones;

FIG. 32B is a schematic diagram showing an example of the 40 MHz OFDMA PPDU having 468 usable tones partitioned into eight (8) DRUs each having 52 tones and two (2) DRUs each having 26 tones, obtained using the DRU-design procedure 300 shown in FIG. 22, wherein the relative prime interleaver uses a tone separation of p=9;

FIG. 33A is a schematic diagram showing an example of a 40 MHz OFDMA PPDU having 476 usable tones partitioned into four (4) RRUs each having 106 tones and two (2) RRUs each having 26 tones.

FIG. 33B is a schematic diagram showing an example of the 40 MHz OFDMA PPDU having 476 usable tones partitioned into four (4) DRUs each having 106 tones and two (2) DRUs each having 26 tones, obtained using the DRU-design procedure 300 shown in FIG. 22, wherein the relative prime interleaver uses a tone separation of p=4;

FIG. 34A is a schematic diagram showing an example of a 40 MHz OFDMA PPDU having 484 usable tones partitioned into two (2) RRUs each having 242 tones;

FIG. 34B is a schematic diagram showing an example of the 40 MHz OFDMA PPDU having 484 usable tones partitioned into two (2) DRUs each having 242 tones, obtained using the DRU-design procedure 300 shown in FIG. 22, wherein the relative prime interleaver uses a tone separation of p=2;

FIG. 35A is a schematic diagram showing an example of an 80 MHz OFDMA PPDU having 936 usable tones partitioned into 36 RRUs each having 26 tones;

FIG. 35B is a schematic diagram showing an example of the 80 MHz OFDMA PPDU having 936 usable tones partitioned into 36 DRUs each having 26 tones, obtained using the DRU-design procedure 300 shown in FIG. 22, wherein the relative prime interleaver uses a tone separation of p=18;

FIG. 36A is a schematic diagram showing an example of an 80 MHz OFDMA PPDU having 936 usable tones partitioned into 16 RRUs each having 52 tones and four (4) RRUs each having 26 tones;

FIG. 36B is a schematic diagram showing an example of the 80 MHz OFDMA PPDU having 936 usable tones partitioned into 16 DRUs each having 52 tones and four (4) DRUs each having 26 tones, obtained using the DRU-design procedure 300 shown in FIG. 22, wherein the relative prime interleaver uses a tone separation of p=18;

FIG. 37A is a schematic diagram showing an example of an 80 MHz OFDMA PPDU having 952 usable tones partitioned into eight (8) RRUs each having 106 tones and four (4) RRUs each having 26 tones;

FIG. 37B is a schematic diagram showing an example of the 80 MHz OFDMA PPDU having 952 usable tones partitioned into eight (8) DRUs each having 106 tones and four (4) DRUs each having 26 tones, obtained using the DRU-design procedure 300 shown in FIG. 22, wherein the relative prime interleaver uses a tone separation of p=8;

FIG. 38 is a flowchart showing a DRU-design procedure using relative prime interleaving with sequence shortening, according to some embodiments of this disclosure;

FIGS. 39A to 39H show an example (for illustrative purposes only, and may not be a real scenario) of the DRU-design procedure using relative prime interleaving with sequence shortening;

FIG. 40A is a schematic diagram showing an example of a 20 MHz OFDMA PPDU having 234 usable tones partitioned into nine (9) RRUs each having 26 tones;

FIG. 40B is a schematic diagram showing an example of the 20 MHz OFDMA PPDU having 234 usable tones partitioned into nine (9) DRUs each having 26 tones, obtained using the DRU-design procedure shown in FIG. 38, wherein the relative prime interleaver uses a tone separation of p=9;

FIG. 41A is a schematic diagram showing an example of a 20 MHz OFDMA PPDU having 234 usable tones partitioned into four (4) 52-tone RRUs and one (1) 26-tone RRU (at the center with two 52-tone RRUs on each side thereof);

FIG. 41B is a schematic diagram showing an example of the 20 MHz OFDMA PPDU having 234 usable tones partitioned into four (4) 52-tone DRUs and one (1) 26-tone DRU, obtained using the DRU-design procedure shown in FIG. 38, wherein the relative prime interleaver uses a tone separation of p=4;

FIG. 42A is a schematic diagram showing an example of a 20 MHz OFDMA PPDU having 238 usable tones partitioned into two (2) 106-tone RRUs and one (1) 26-tone RRU (at the center with one 106-tone RRU on each side thereof);

FIG. 42B is a schematic diagram showing an example of the 20 MHz OFDMA PPDU having 238 usable tones partitioned into two (2) 106-tone DRUs and one (1) 26-tone DRU, obtained using the DRU-design procedure shown in FIG. 38, wherein the relative prime interleaver uses a tone separation of p=2.

FIG. 43 is a schematic diagram showing a DRU plan having three (3) 52-tone DRUs and three (3) 26-tone DRUs with a tone separation p=4;

FIG. 44 is a schematic diagram showing a DRU plan having at least having two 106-tone DRUs with a tone separation p=2;

FIG. 45 is a schematic diagram showing converting a first usable-tone sequence having a length of 236 to a first usable-tone sequence having a length of 238 by inserting two dummy tones into the first usable-tone sequence;

FIG. 46 is a schematic diagram showing a DRU plan having one (1) 106-tone DRU, two (2) 52-tone FRUs, and one (1) 26-tone FRU with a tone separation p=2;

FIG. 47 is a schematic diagram showing obtaining the tone distribution in a 52+26-tone multiple DRU (M-DRU) based on the DRU plan shown in FIG. 29B having four (4) 52-tone DRUs and one 26-tone DRU, according to some embodiments of this disclosure;

FIGS. 48A to 48C are schematic diagrams showing obtaining M-DRUs by combining tones shown in FIG. 47, according to some embodiments of this disclosure;

FIGS. 49A and 49B are schematic diagrams showing obtaining M-DRUs by combining tones shown in FIG. 30B, according to some embodiments of this disclosure;

FIG. 50 is a flowchart showing a DRU-design procedure with puncturing using (modified) relative prime interleaving, according to some embodiments of this disclosure;

FIG. 51 shows an example on tone distribution of three 242-tone DRUs in an 80 MHz TB PPDU with the second 20 MHz subchannel being unallocated or punctured, using the procedure shown in FIG. 50; and

FIGS. 52A to 52C show the three 242-tone DRUs in FIG. 51 obtained using the procedure shown in FIG. 50.

### DETAILED DESCRIPTION

Embodiments disclosed herein relate to systems, apparatuses, methods, and non-transitory computer-readable storage devices or media for wireless communication employing distributive resource units. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

### A. System Structure

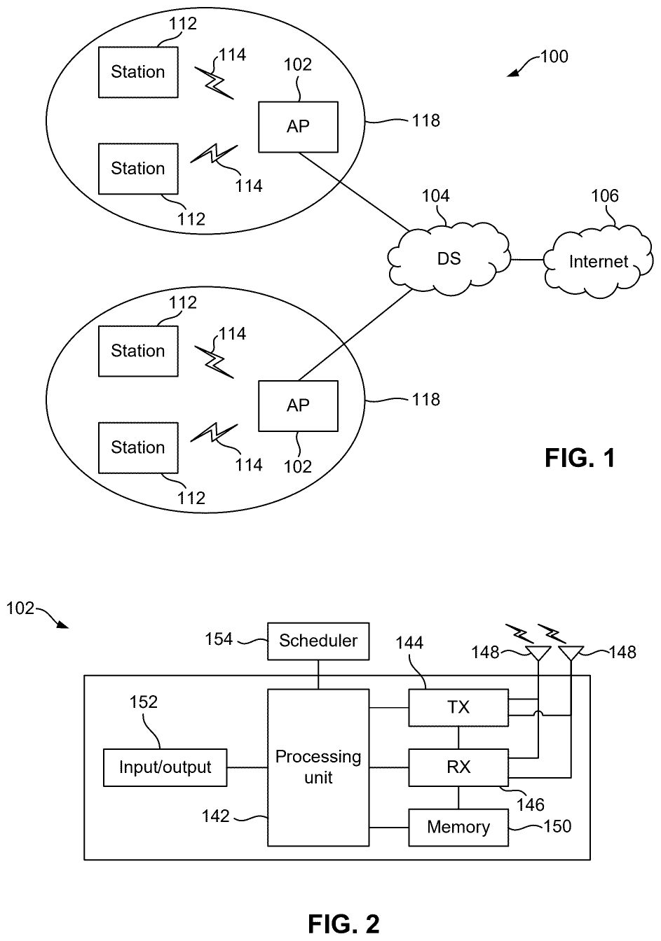

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

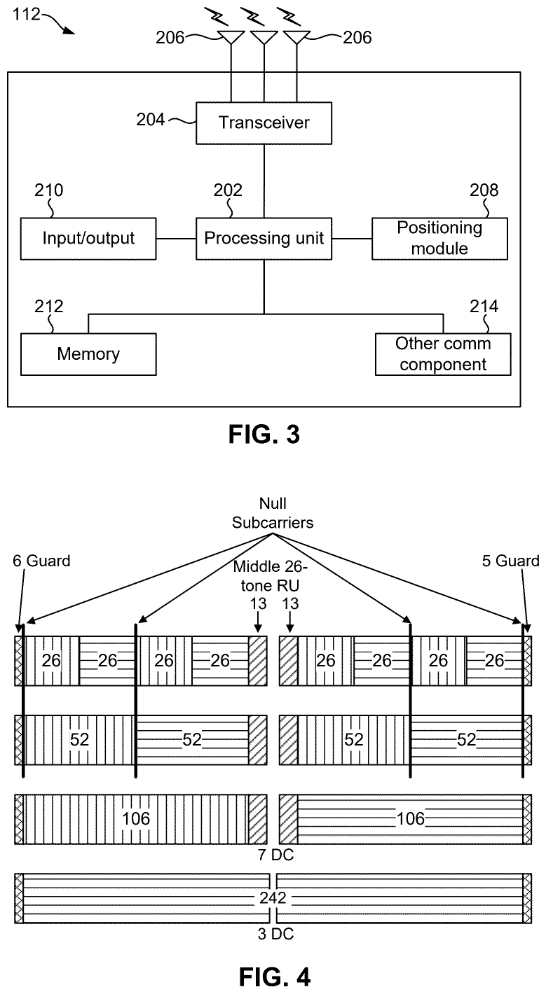

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Globa “naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Orthogonal Frequency Division Multiple Access and Resource Units

### B-1. Resource Units and Tone Distributions

Some wireless communication systems such as IEEE 802.11ax (WI-FI® 6) systems use OFDMA for multiple access. Generally, OFDMA uses orthogonal frequency division multiplexing (OFDM) for multiple users to transmit data at the same time.

For example, in an IEEE 802.11ax system, a device such as an AP 102 or a STA 112 transmits data using physical layer protocol data units (PPDUs). A PPDU contains a preamble and a data field containing one or more OFDM symbols. As those skilled in the art understand, an OFDM symbol combines data elements into a plurality of subcarriers (also called “tones”) and uses the so-called cyclic prefix for combating inter-symbol interferences. The number of tones in an OFDM symbol depends on the bandwidth (BW) thereof. In IEEE 802.11ax, the subcarrier spacing is 78.125 kilohertz (kHz), and the OFDM BW (that is, the BW of OFDM symbols; also denoted “OFDMA BW” when OFDMA is used) may be 20 MHz, 40 MHz, or 80 MHz. Correspondingly, the number of OFDM tones (that is, the tones in an OFDM symbol; also denoted “OFDMA tones” hereinafter when OFDMA is used) may be 256, 512, or 1024. Some of these tones are unused, including direct-current (DC) tones (also called direct-conversion tones, which include the tone whose frequency is equal to the RF carrier frequency, and some neighboring tones thereof), guard tones, and null tones. Therefore, the usable tones are generally a subset of the total OFDM tones.

When OFDMA is used, the usable OFDMA tones or subcarriers are partitioned into a plurality of resource units (RUs) for assigning to a plurality of users for data and pilot transmission. In an OFDMA transmission, each RU in a PPDU is assigned to a specific STA so that the data of multiple STAs can be multiplexed within a single PPDU.

In prior art, consecutive-tone RUs (denoted “regular RUs” or “RRUs” hereinafter) are used, wherein each RU consists of a plurality of consecutive tones. The smallest number of tones of a RU is 26 tones which forms the base RU size and the bigger size of RU has been built up based on the 26-tone RU.

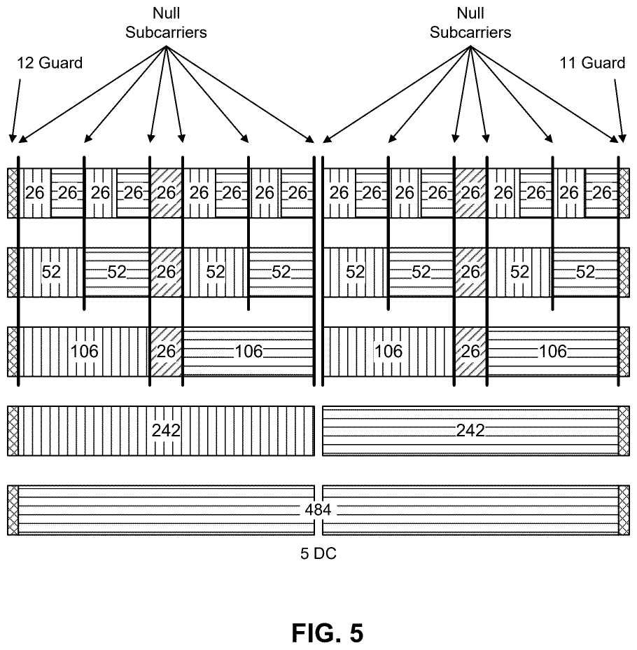

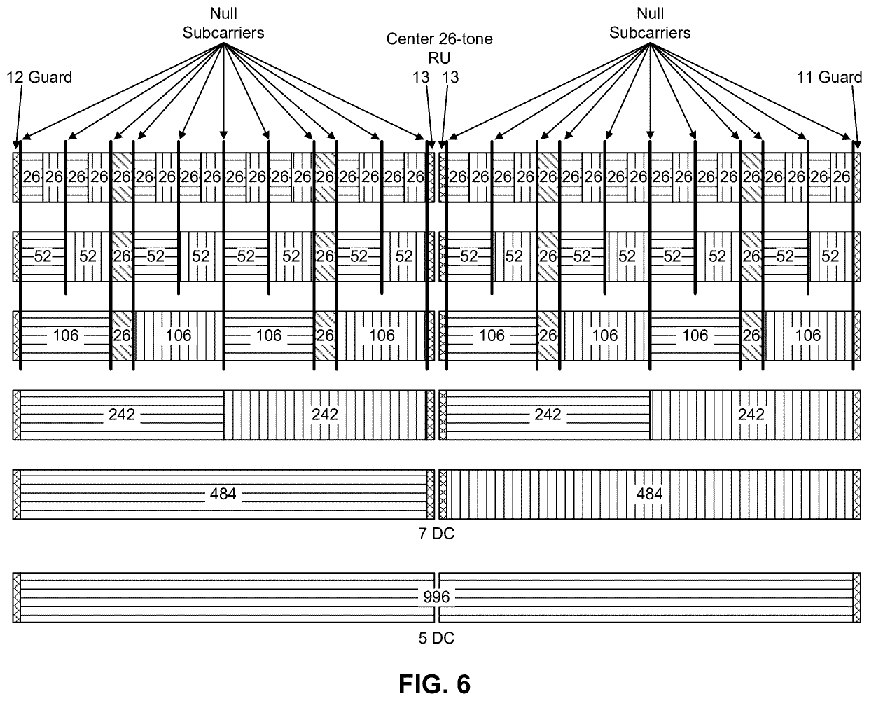

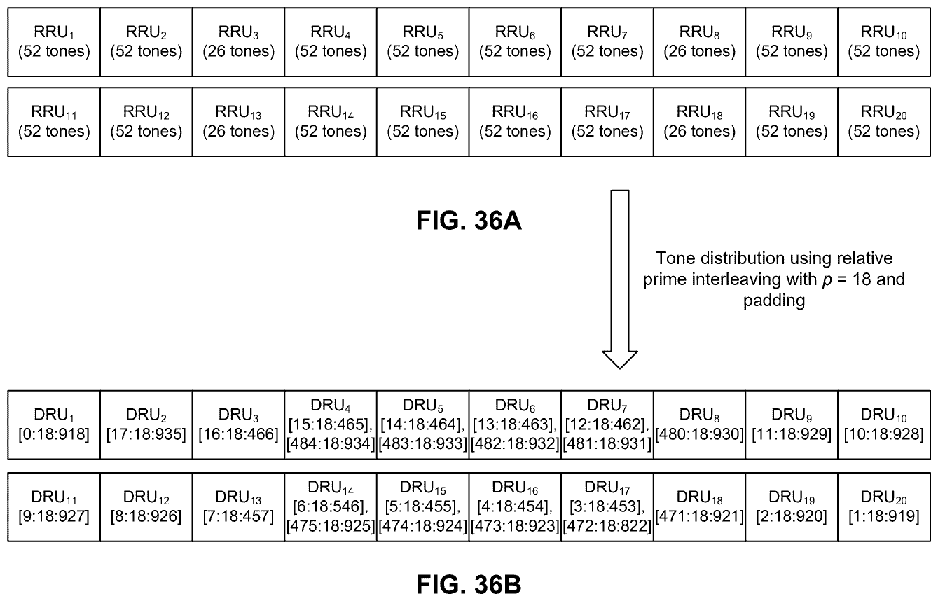

For example, FIGS. 4 and 5 show the RU locations in a 20 MHz and a 40 MHz High Efficiency/Enhanced High Throughput (HE/EHT) (HE; defined in IEEE 802.11ax) PPDU, respectively (reproduced from FIG. 27-5 and FIG. 27-6, subclause 27.3.2.2, IEEE P802.11-REVme/D4.1). FIG. 6 shows the RU locations an 80 MHz EHT PPDU (see FIG. 36-4, subclause 36.3.2.1, IEEE P802.11be/D5.0).

In the 6 GHz low power indoor (LPI) bands, regulatory bodies such as Federal Communications Commission (FCC) apply stringent rules on the limit of maximum Equivalent isotropic radiated power (EIRP) power spectral density (PSD), for example, −1 decibel-milliwatts per megahertz (dBm/MHz) for non-AP STA 112. This limits the transmission range and/or reduces transmission rates.

IEEE 802.11bn (Ultra-high reliability (UHR)) standardization is currently under development for a next generation of WLANs. One of the most important goals for UHR is to improve the reliability. FCC allocates about the 1.2 GHz unlicensed spectrum for low power indoor applications at the 6 GHz band. FCC regulates the maximum conducted output power spectrum density (PSD) as: 5 dBm/MHz for an AP; −1 dBm/MHz for a STA. These FCC regulation rules significantly limit the transmit power of a Wi-Fi AP/STA operating in the 6 GHz LPI band compared to those operations in other unlicensed bands. This may result in much shorter communication links and/or lower reliability.

Distributed resource units (DRU) (see IEEE 802.11-23-0037r0) may also be used to distribute tones of a user in an OFDMA system across a wide portion of spectrum within the PPDU bandwidth. In other words, the concept of DRU is to distribute the contiguously allocated data/pilot tones in a RRU (currently specified in 802.11) over a broader spectrum shared with other RUs. Therefore, a separation of data/pilot tones in DRU is required to be a multiple of subcarrier spacing specified in 802.11ax/be and the transmit power of each distributed tone in a DRU can be boosted under the regulation on the output PSD. More specifically, by using DRU, the number of tones of one user within one (1) MHz is reduced and the transmit power can be boosted, which may increase the transmit distance and/or improve the reliability for the STAs operating in the LPI bands.

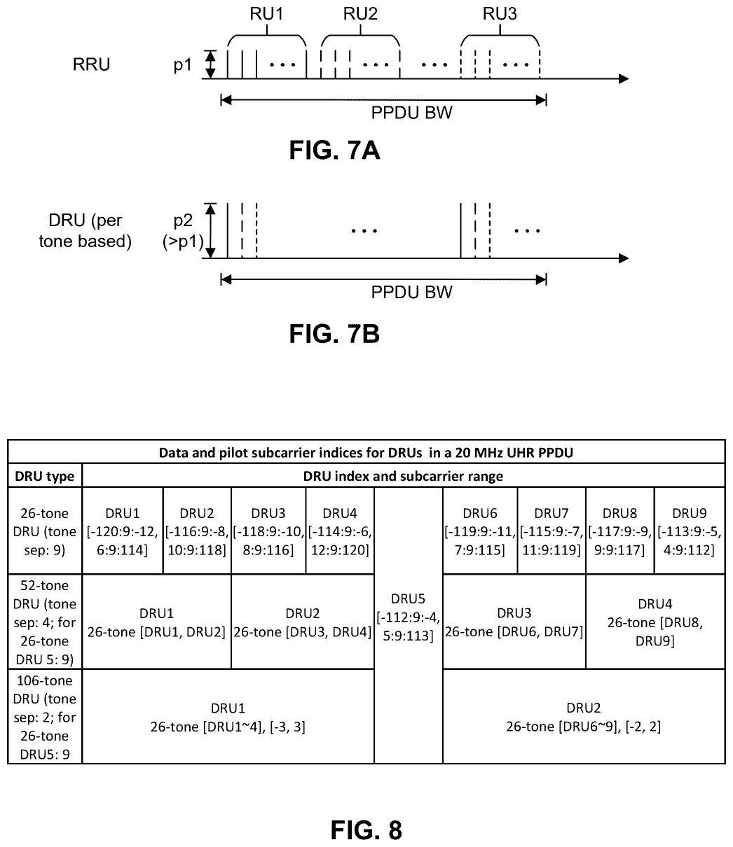

FIGS. 7A and 7B illustrate the RRUs (FIG. 7A) and the DRUs (FIG. 7B) in the BW of a PPDU. The transmit power p2 of each tone in DRUs may be allowed to be greater than the transmit power p1 of each tone in RRUs because of the tone distribution.

FIGS. 8 to 10 show the tables of DRU tone plans for distribution BWs of 20 MHz, 40 MHZ, and 80 MHz, respectively, considered in IEEE 802.11-24-0468r1. As can be seen, some DRU tone plans have different tone separations. For example, as shown in FIG. 8, the 52-tone DRU tone plan comprises DRU1, DRU2, DRU3, and DRU4, each of which has a tone separation of four (4) tones. However, DRU5 in the 26-tone DRU tone plan has a tone separation of nine (9) tones.

As those skilled in the art will appreciate, DRU tone distribution is important for system performance and implementation. The different tone separations in different DRUs may lower the system performance and/or may cause implementation difficulties.

For example, in the DRU tone plan for distribution BW of 20 MHz shown in FIG. 8, the tone separations in DRUs of different sizes are different for different users in OFDMA (for example, for the mixed 52-tone DRUs having a tone separation of four (4) tones and the 26-tone DRU, DRU5, having a tone separation of nine (9) tones, and for the mixed 106-tone DRUs having a tone separation of two (2) tones and the 26-tone DRU, DRU5, having a tone separation of nine (9) tones).

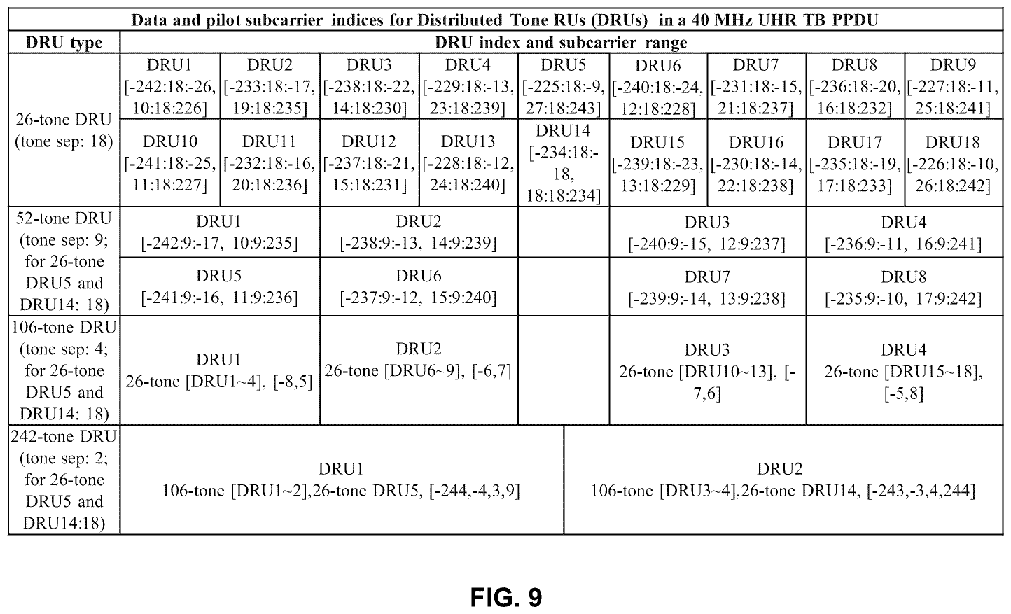

In the DRU tone plan for distribution BW of 40 MHz shown in FIG. 9, the subcarrier separations of different sizes of in DRUs are different for different users in OFDMA (for example, for the mixed 52-tone DRUs having a tone separation of nine (9) tones and the 26-tone DRUs, DRU5, DRU14, having a tone separation of 18 tones, and for the mixed 106-tone DRUs having a tone separation of three (3) or four (4) tones and the 26-tone DRUs, DRU5, DRU14, having a tone separation of 18 tones).

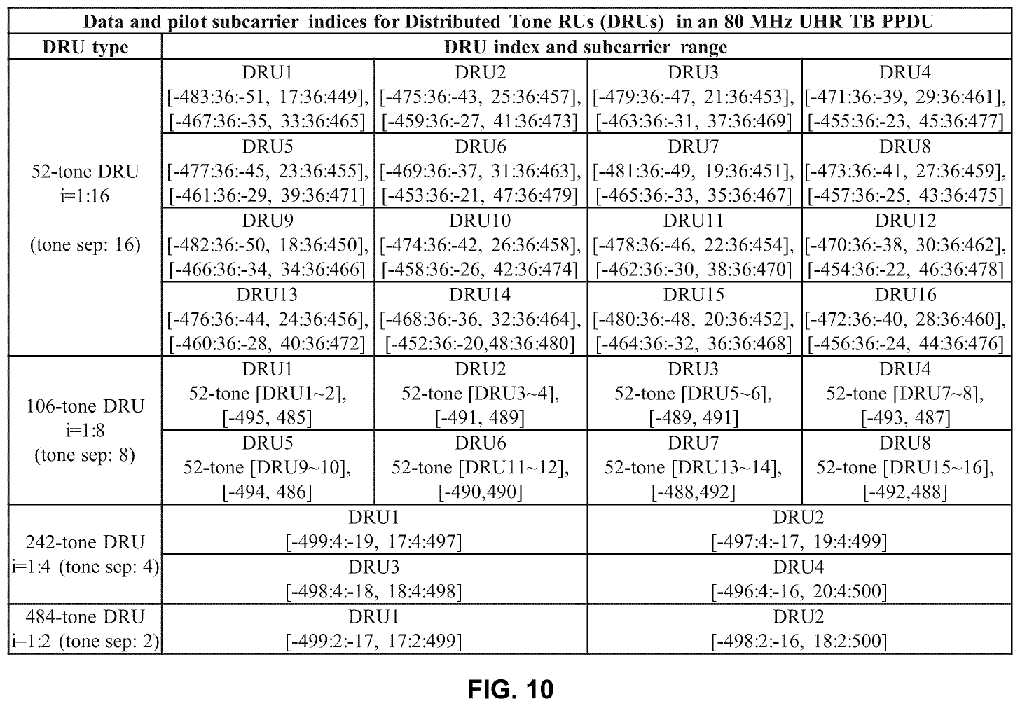

In the DRU tone plan for distribution BW of 80 MHz shown in FIG. 10, the subcarriers are equally separated for all DRUs. However, this DRU tone plan does not have any arrangement with mixed 52-tone and 26-tone DRUs, nor with mixed 106-tone and 26-tone DRUs, thereby resulting in a spectrum efficiency loss of about 11%.

### B-2. Tone Distribution Based on Prime Interleaving

In view of above-described disadvantages, in some embodiments, the communication system 100 uses OFDMA (denoted a “OFDMA system”) for multiple access, and uses a DRU tone plan with a substantially uniform (or nearly uniform) tone separation for maintaining same performance across different users.

More specifically, in these embodiments, the tones of a DRU for a STA 112 (including data tones and pilot tones) are substantially uniformly (or nearly uniformly, or as uniformly as possible) distributed over the BW of the DRU, so as to maximize the per tone power based on the regulatory bodies' PSD limitation rules. Here, the BW of a DRU refers to the BW from the lowest-frequency tone of the DRU to the highest-frequency tone thereof. Note that, with this definition, each DRU shares its BW with one or more other DRUs.

Various methods for designing such a substantially uniform DRU tone distribution are available. Preferably, the design method is flexible for different DRU sizes (in terms of the total number of tones of each DRU) and different PPDU BWs. Practical implementation and simple signaling for tone distribution are also desirable. Moreover, it is preferable that the DRUs has the same set of RU sizes as corresponding RRUs.

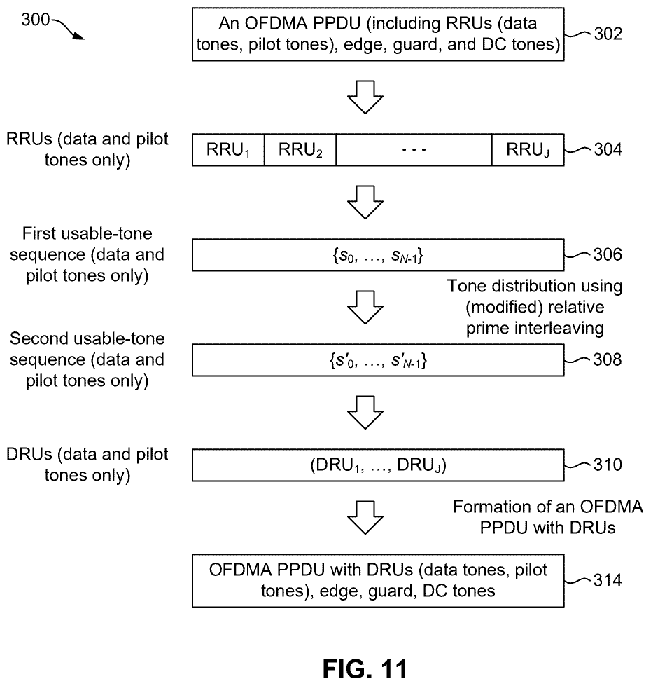

FIG. 11 is a flowchart showing a procedure 300 of designing or otherwise obtaining DRUs in an OFDMA PPDU with substantially uniform tone distribution using (modified) relative prime interleaving.

As described above, the tones of the OFDMA PPDU 302 may be classified as various types of tones based on the usage thereof, including usable tones (such as tones for transmitting data symbols (denoted “data tones”), tones for transmitting pilot symbols (denoted “pilot tones”), and/or the like) and unusable tones (such as edge tones, guard tones, DC tones, and/or the like).

The usable tones of the OFDMA PPDU 302 have been partitioned into J RRUs 304, with the j-th RRU, denoted RRUⱼ (j=1, . . . , J) having Nⱼ usable tones for STAⱼ. For example, the J RRUs 304 may be obtained in accordance with relevant standards (for example, in accordance with the tone plan shown in FIG. 4, FIG. 5, or FIG. 6 depending on the BW of the PPDU 302).

Then, a first usable-tone sequence 306 is obtained by concatenating the J RRUs. The length of the first usable-tone sequence 306 is

$$N = {\sum }_{j = 1}^{J} {N}_{j} .$$

The first usable-tone sequence 306 is then interleaved, shuffled, or otherwise reordered by using a suitable interleaver (or a suitable interleaving method) to generate a second usable-tone sequence 308 (also denoted a “reordered usable-tone sequence”).

Interleavers have been widely used in other fields of communication systems, wherein an interleaver reorders a sequence of symbols in a one-to-one mapping manner. For example, the relative prime interleavers (also called “relative prime interleaving”), which have been used in turbo coding in 3GPP LTE cellular systems, are proven practical interleavers with good symbol-spreading properties and ease of implementation.

A relative prime interleaver interleaves, shuffles, or otherwise reorders the symbols in a length-N input sequence {sₙ} (n=0, . . . , N−1) to obtain an output sequence {sₖ′}={sₖ₍ₙ₎′} with a specific distance or spacing over a Galois field of size N (denoted GF(N)), wherein the relationship between the index n of the input sequence and the index k of the output, interleaved sequence is:

$$k = k ( n ) = ( p \cdot n ) mod N \qquad ( 1 )$$

for n=0, . . . , N−1, where “x mod y” represents the modulo function calculating the remainder of x divided by y, p is a parameter and is a relative prime with N (that is, p and N have no common factors other than one (1)), and sₖ′=sₖ₍ₙ₎′=sₙ, for n=0, . . . , N−1. Thus, the interleaved sequence {sₖ′}={sₖ₍₀₎, . . . , s_{k(N-1)}}.

In these embodiments, a relative prime interleaver is used to interleave, shuffle, or otherwise reorder the first usable-tone sequence 306, with N being the total number of usable tones and

$$N = {\sum }_{j = 1}^{J} {N}_{j} ,$$

and p being the tone separation in each DRU, that is, p is the distance or spacing between neighboring tones in each DRU. A second usable-tone sequence 308 is then obtained.

The second usable-tone sequence 308 is partitioned into J DRUs 310 with the length of each DRU 310 being the same as the length of the corresponding RRU 304. In other words, length (DRUⱼ)=length(RRUⱼ)=Nⱼ, (j=1, . . . , J), where length (x) representing the length of x, and DRUⱼ represents the j-th DRU.

After the J DRUs 310 are obtained, the unusable tones such as the edge tones, guard tones and DC tones are inserted into the OFDMA PPDU based on the desired subcarrier and resource allocation in the PPDU (for example, at their original locations), thereby obtaining an OFDMA PPDU 314 with J DRUs. The obtained PPDU 310 then comprises J DRUs 310 having tones separated as uniformly as possible.

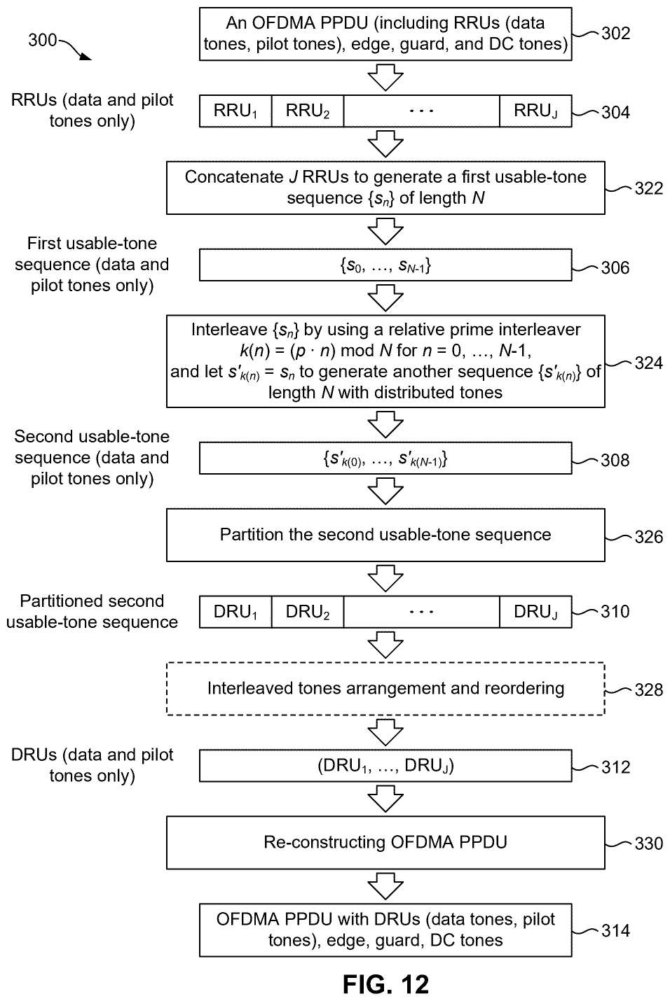

FIG. 12 is a flowchart showing the details of the DRU-design procedure 300.

As shown, the usable tones of the OFDMA PPDU 302 have been partitioned into J RRUs 304 in accordance with relevant standards, with the RRUⱼ (j=1, . . . , J) having Nⱼ usable tones for STAⱼ.

At step 322, the J RRUs are concatenated to form a first usable-tone sequence 306, that is, {sₙ} (n=0, . . . , N−1), with a length of

$$N = {\sum }_{j = 1}^{J} {N}_{j} .$$

At step 324, the first usable-tone sequence 306 is interleaved, shuffled, or otherwise reordered by using a relative prime interleaver with a desired tone separation p, in accordance with Equation (1) to obtain a second usable-tone sequence 308 (also denoted a “reordered usable-tone sequence”) as {sₖ₍ₙ₎′}, where n=0, . . . , N−1,

$$k ( n ) = ( p \cdot n ) mod N , \qquad ( 1 )$$

$$and {s}_{k ( n )}^{′} = {s}_{n} .$$

At step 326, the second usable-tone sequence 308 is partitioned into J DRUs 310 with each DRU, DRUⱼ, corresponds to a respective RRU, RRUⱼ. That is, DRUⱼ has the same number Nⱼ of tones as RRUⱼ, and starts at the same position in the second usable-tone sequence as the starting position of RRUⱼ in the first usable-tone sequence. In other words, if RRUⱼ comprises tones s_{n_j1} to s_{n_j2}, in {sₙ}, then DRUⱼ comprises tones s_{k (n_j1)}′ to s_{k(n_j2)}′ in {sₖ₍ₙ₎′}. Note that the partitioned second usable-tone sequence 310 is ordered in accordance with n=0, . . . , N−1.

Optionally, at step 328, the partitioned second usable-tone sequence 310 is reordered in accordance with k from 0 to N−1.

At step 330, the DRUs 310 are combined with the unusable tones (such as guard tones, edge tones, DC tones, null tones, and/or the like, which may be added to their original locations) to obtain a PPDU 314 with DRUs.

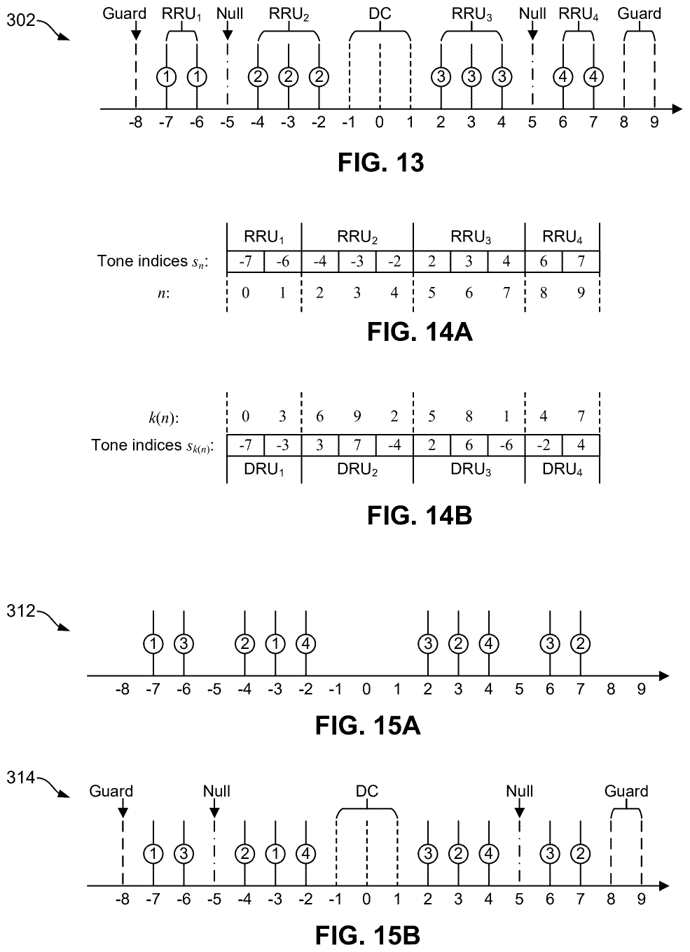

FIGS. 13 to 15B show an example (for illustrative purposes only, and may not be a real scenario). As shown, an OFDMA PPDU 302 has 18 tones including N=10 usable tones and eight (8) unusable tones. The 10 usable tones are partitioned into J=4 RRUs, RRU₁ to RRU₄, with RRU₁ comprising tones −7 and −6, RRU₂ comprising tones −4, −3, and −2, RRU₃ comprising tones 2, 3, and 4, and RRU₄ comprising tones 6 and 7. The eight (8) unusable tones include three DC tones −1, 0, and 1, two null tones −5 and 5, and three guard tones −8, 8, and 9.

As shown in FIG. 14A, the four (4) RRUs are concatenated (step 322) to form a first usable-tone sequence {sₙ}={−7, −6, −4, −3, −2, 2, 3, 4, 6, 7} with indices of the first usable-tone sequence being n=0, . . . , 9.

Now, a DRU plan is to be designed for this PPDU 302, wherein the DRU plan has four (4) DRUs each corresponding to a respective RRU and having a tone separation p=3.

As shown in FIG. 14B, the indices of the first usable-tone sequence are input to the relative prime interleaver to obtain k(n)=0, 3, 6, 9, 2, 5, 8, 1, 4, 7 for n=0, . . . , 9 (step 324). Thus, the second usable-tone sequence 308 is {sₖ₍ₙ₎′}={−7, −3, 3, 7, −4, 2, 6, −6, −2, 4}.

At step 326, by partitioning {sₖ₍ₙ₎′} into four (4) DRUs corresponding to the four (4) RRUs, the four (4) DRUs are obtained as: DRU₁=[−7, −3], DRU₂=[3, 7, −4], DRU₃=[2, 6, −6], and DRU₄=[−2, 4]. As shown in FIG. 14B, the partitioned second usable-tone sequence 310 is ordered in accordance with n=0, . . . , 9.

At step 328, the partitioned second usable-tone sequence 310 is reordered in accordance with k(n)=0, . . . , 9. The reordered second usable-tone sequence 312 is shown in FIG. 15A, wherein the circled numbers represent the DRU indices.

At step 330, the four (4) DRUs are then combined with the eight (8) unusable tones with the unusable tones inserted into their original locations. A PPDU 314 with four (4) DRUs are then obtained as shown in FIG. 15B.

As those skilled in the art will appreciate, by using the DRU-design procedure 300 shown in FIG. 12, existing HE/EHT RU allocations and tone plans may be reused without any change, while tones in each RRU may be distributed with substantially equal tone separation in the corresponding DRU with desired tone separations. The DRUs maintain the same spectrum efficiency as RRUs specified in HE and EHT.

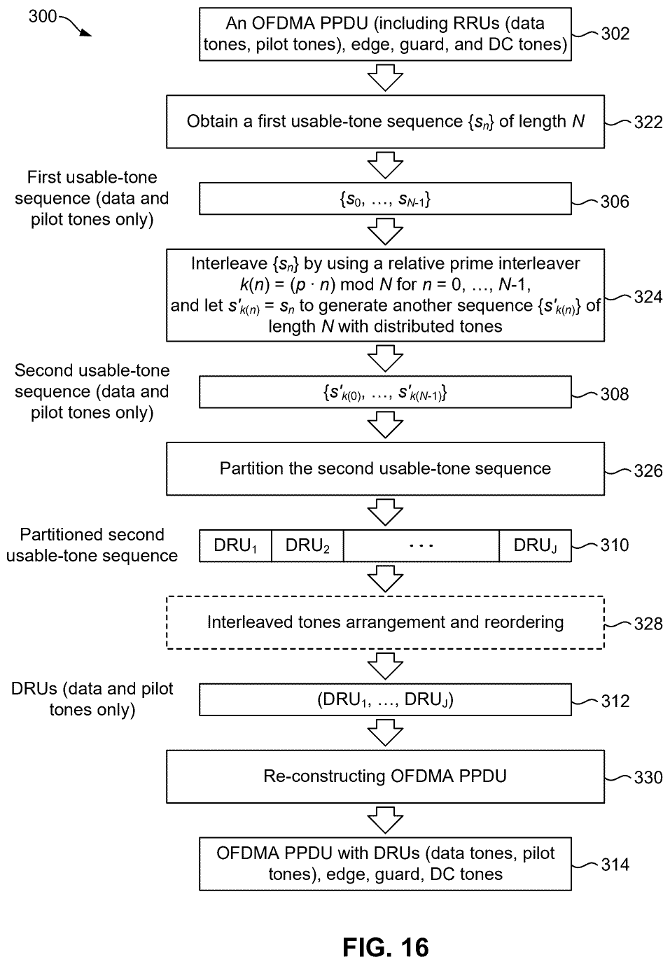

Those skilled in the art will appreciate that, in some embodiments, designing the DRUs do not need to define RRUs first. FIG. 16 shows the DRU-design procedure 300 in these embodiments, which is similar to that shown in FIG. 12 except that the DRU-design procedure 300 does not leverage any RRUs and step 322 is changed to “obtain a first usable tone sequence {sₙ} of length N” without using any RRUs as reference. Rather, in these embodiments, the DRU plan requires arrangement of J DRUs, with DRUⱼ having Nⱼ tones (j=1, . . . , J), and a tone separation of p that is a relative prime of

$$N = {\sum }_{j = 1}^{J} {N}_{j} .$$

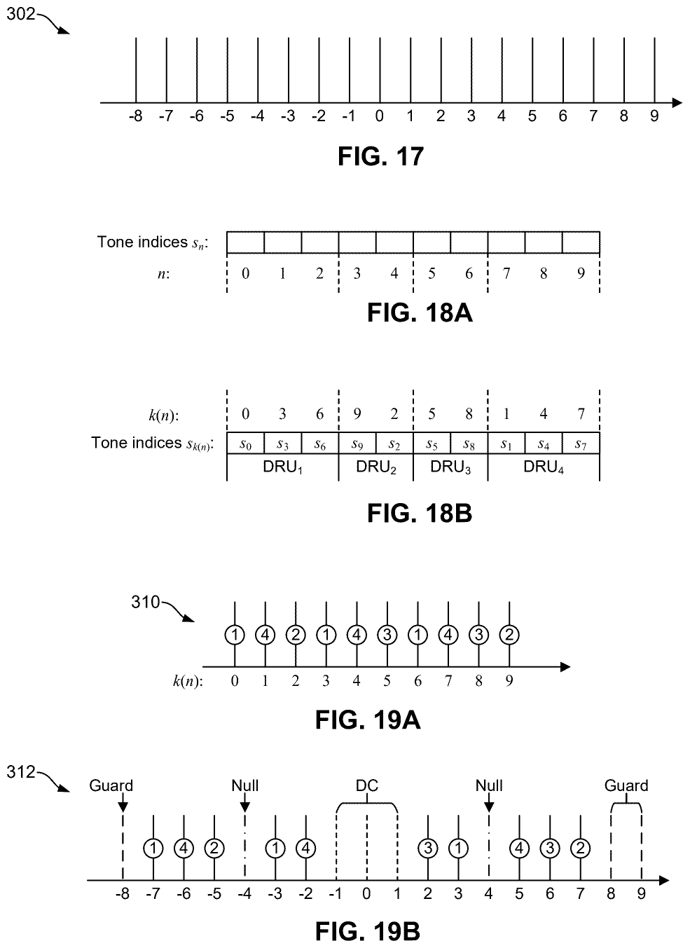

For example, as shown in FIG. 17, a PPDU 302 comprises 18 tones including N=10 usable tones and eight (8) unusable tones. The eight (8) unusable tones include three DC tones at the center of the PPDU spectrum, two null tones, and three guard tones at the two ends of the PPDU spectrum. The 10 usable tones are to be partitioned into four DRUs with two DRUs each having three (3) tones and the other two DRUs each having two (2) tones. The tone separation is p=3.

As shown in FIG. 18A, a first usable-tone sequence {sₙ}={s₀, s₁, s₂, s₃, s₄, s₅, s₆, s₇, s₈, s₉} is formed. The indices of the first usable-tone sequence are n=0, . . . , 9. However, as there is no a priori information regarding where the usable tones are located, the values of s₀ to s₉ are unknown.

As shown in FIG. 18B, the indices of the first usable-tone sequence are input to the relative prime interleaver to obtain k(n)=0, 3, 6, 9, 2, 5, 8, 1, 4, 7 for n=0, . . . , 9. Thus, the second usable-tone sequence 308 is {sₖ₍ₙ₎′}={s₀, s₃, s₆, s₉, s₂, s₅, s₈, s₁, s₄, s₇}.

The second usable-tone sequence {sₖ₍ₙ₎′} is partitioned into four (4) DRUs, for example, DRU₁=[s₀, s₃, s₆], DRU₂=[s₉, s₂], DRU₃=[s₅, s₈], and DRU₄=[s₁, s₄, s₇]. FIG. 19A shows the DRU distribution with respect to k(n), wherein the circled numbers represent the DRU indices.

The four (4) DRUs are then combined with the eight (8) unusable tones by inserting the unusable tones into suitable locations. A PPDU 314 with four (4) DRUs are then obtained as shown in FIG. 19B.

Those skilled in the art will appreciate that, in these embodiments, the null tones are optional. In other words, the PPDU 314 with J DRUs may comprise null tones for, for example, compatibility with existing standards and/or technologies. Alternatively, the PPDU 314 with J DRUs may not comprise null tones if, for example, compatibility is not a consideration.

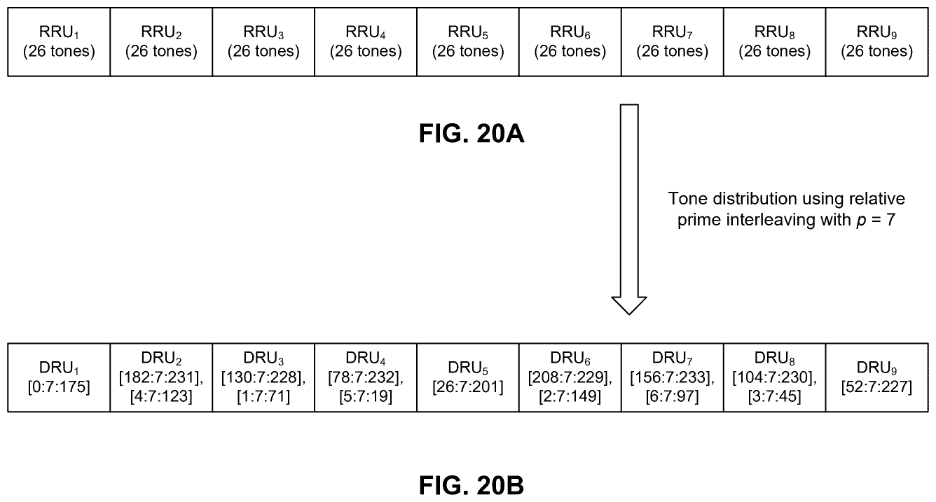

FIGS. 20A and 20B show an example of RU partitioning for a 20 MHz OFDMA PPDU having 234 usable tones. For ease of illustration, unusable tones are not shown.

FIG. 20A shows the prior-art partitioning wherein the usable tones of the 20 MHz OFDMA PPDU are partitioned into nine (9) RRUs each having 26 tones.

FIG. 20B shows the DRU partitioning wherein the usable tones of the 20 MHz OFDMA PPDU are partitioned using a relative prime interleaver with a tone separation p=7, into nine (9) DRUs each having 26 tones. In FIG. 20B, the notation “[a:b:c]” refers to numbers starting from a to c with an incremental step of b (that is, the numbers of a, a+b, a+2b, . . . , c).

More specifically, the DRUs are:
DRU₁: [0:7:175];
DRU₂: [182:7:231] and [4:7:123];
DRU₃: [130:7:228] and [1:7:71];
DRU₄: [78:7:232] and [5:7:19];
DRU₅: [26:7:201];
DRU₆: [208:7:229] and [2:7:149];
DRU₇: [156:7:233] and [6:7:97];
DRU₈: [104:7:230] and [3:7:45]; and
DRU₉: [52:7:227].

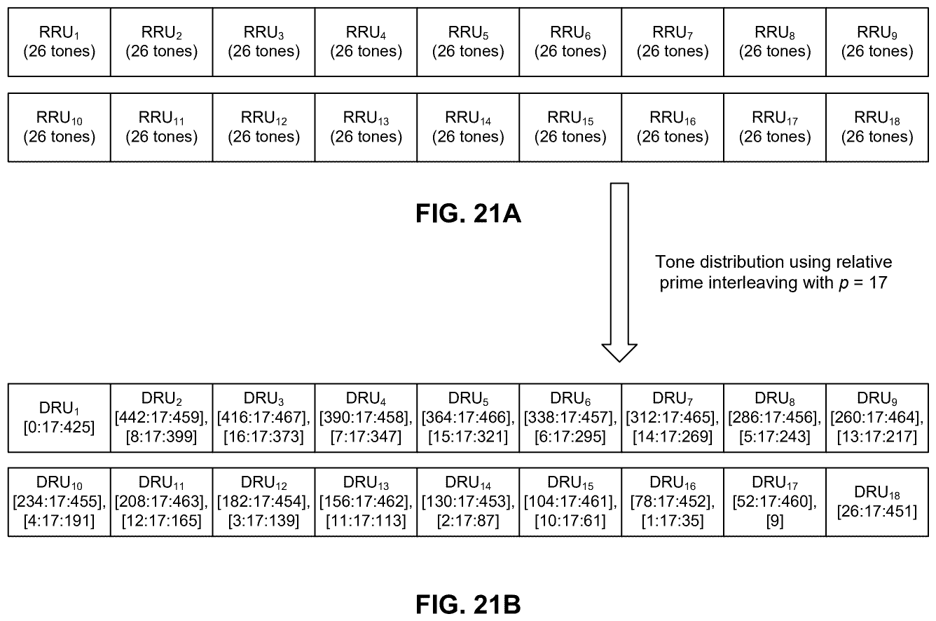

FIGS. 21A and 21B show an example of RU partitioning for a 40 MHz OFDMA PPDU having 468 usable tones. For ease of illustration, unusable tones are not shown.

FIG. 21A shows the prior-art partitioning wherein the usable tones of the 40 MHz OFDMA PPDU are partitioned into 18 RRUs each having 26 tones.

FIG. 21B shows the DRU partitioning wherein the usable tones of the 40 MHz OFDMA PPDU are partitioned using a relative prime interleaver with a tone separation p=17, into 18 DRUs each having 26 tones. In some embodiments, a tone separation p=13 may alternatively be used. Either p=13 or p=17 ensures that there exists only one tone per MHz. In this way, maximum per tone power can be transmitted under the FCC's rule on transmit power PSD.

More specifically, the DRUs are:
DRU₁: [0:17:425];
DRU₂: [442:17:459] and [8:17:399];
DRU₃: [416:17:467] and [16:17:373];
DRU₄: [390:17:458] and [7:17:347];
DRU₅: [364:17:466] and [15:17:321];
DRU₆: [338:17:457] and [6:17:295];
DRU₇: [312:17:465] and [14:17:269];
DRU₈: [286:17:456] and [5:17:243];
DRU₉: [260:17:464] and [13:17:217];
DRU₁₀: [234:17:455] and [4:17:191];
DRU₁₁: [208:17:463] and [12:17:165];
DRU₁₂: [182:17:454] and [3:17:139];
DRU₁₃: [156:17:462] and [11:17:113];
DRU₁₄: [130:17:453] and [2:17:87];
DRU₁₅: [104:17:461] and [10:17:61];
DRU₁₆: [78:17:452] and [1:17:35];
DRU₁₇: [52:17:460] and [9]; and
DRU₁₈: [26:17:451].

In some embodiments, the DRU design methods described herein may partition an OFDMA PPDU into DRUs with different DRU sizes. In some embodiments, it may be preferable to have substantially the same tone separation for different DRU sizes.

In above embodiments, the tone separation p is a relative prime of the total number N of usable tones. In some embodiments, the tone separation p is a relative prime of the total number N of usable tones and p·max(Nⱼ)<N, where max(Nⱼ) refers to the maximum of Nⱼ for j=1, . . . , J (that is, the largest size of a DRU).

In above embodiments, the tone separation p has to be carefully selected such that p is a relative prime of N, or such that p is a relative prime of N and p·max(Nⱼ)<N.

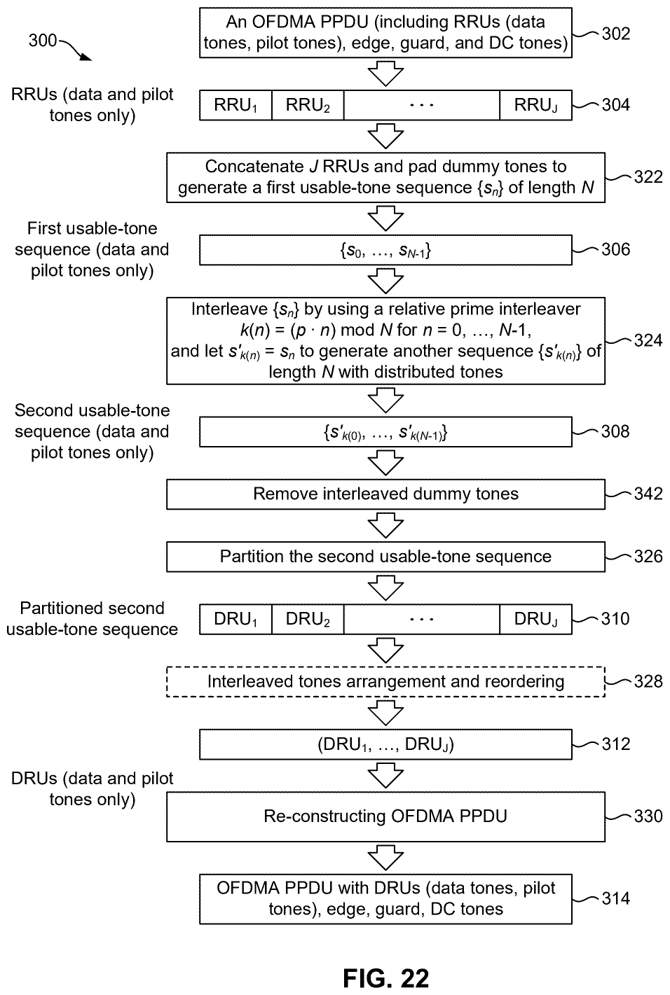

FIG. 22 is a flowchart showing the DRU-design procedure 300, according to some embodiments of this disclosure. The DRU-design procedure 300 is similar to that shown in FIG. 12 except the step 322 is different and a new step 342 is added, which will be described in more detail below.

In these embodiments, the tone separation p is not a relative prime of the number of usable tones, denoted

$${N}_{u} = {\sum }_{j = 1}^{J} {N}_{j} .$$

Therefore, at step 322, the first usable-tone sequence {sₙ} is obtained by concatenating the J RRUs 304 to form an initial usable-tone sequence, and padding N_{pad} dummy tones thereto (each dummy tone being represented by, for example, a predefined value) to obtain the first usable-tone sequence 306, such that the tone separation p is a relative prime of the length of the first usable-tone sequence {sₙ},

$$N = {\sum }_{j = 1}^{J} {N}_{j} + {N}_{pad} .$$

Here, N_{pad}≥1 is the smallest integer that makes the tone separation p a relative prime of the length of the first usable-tone sequence {sₙ},

$$N = {\sum }_{j = 1}^{J} {N}_{j} + {N}_{pad} .$$

At step 324 (which is the same as that shown in FIG. 12), the second usable-tone sequence {s_{k(n)′}} is obtained.

Then, the N_{pad} dummy tones are removed (step 342), and the shortened second usable-tone sequence is partitioned into J DRUs (step 326, which is the same as that shown in FIG. 12). The rest of the procedure 300 (such as steps 328 and 330) are the same as those shown in FIG. 12.

In some embodiments, the tone separation p is not a relative prime of the number of usable tones,

$${N}_{u} = {\sum }_{j = 1}^{J} {N}_{j} .$$

Therefore, at step 322, the first usable-tone sequence {sₙ} is obtained by concatenating the J RRUs 304 and padding N_{pad} dummy tones (represented by, for example, a predefined value), where N_{pad}≥1 is an integer, such that:
the tone separation p is a relative prime of the length of the first usable-tone sequence {sₙ},

$$N = {\sum }_{j = 1}^{J} {N}_{j} + {N}_{p a d} ,$$

and
p≤┌N/(max(Nⱼ))┐, j=1, . . . , J, and p≤┌N/(Nⱼ+N_{pad})┐, where ┌x┐ is function calculating the smallest integer that is greater than or equal to x.

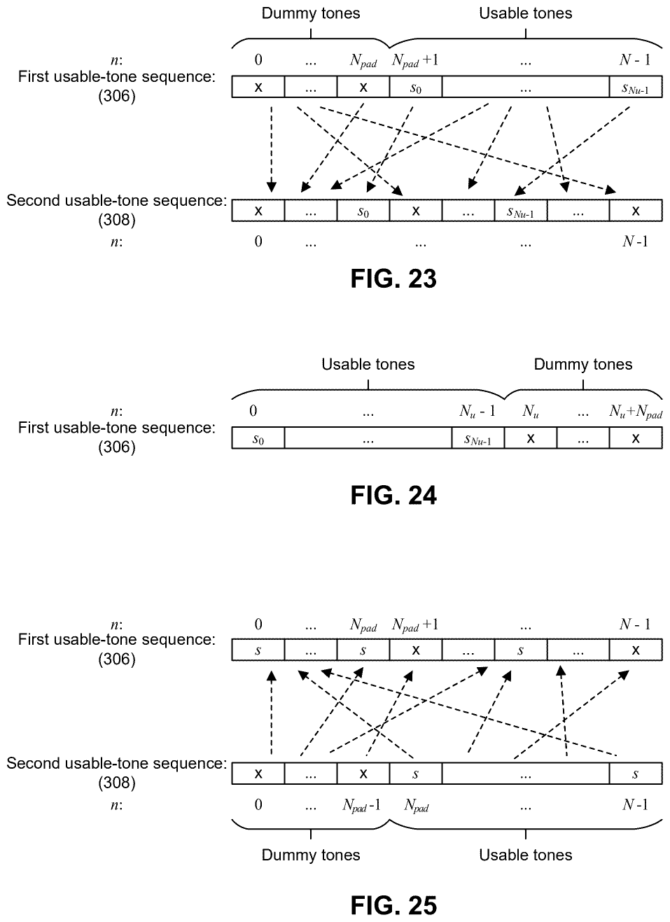

In above embodiments, the N_{pad} dummy tones may be padded at any suitable positions of the initial usable-tone sequence. For example, as shown in FIG. 23, the N_{pad} dummy tones may be padded to the beginning of the initial usable-tone sequence such that the first N_{pad} elements of the first usable-tone sequence 306 correspond to the N_{pad} dummy tones. After interleaving, the N_{pad} dummy tones are distributed in the second usable-tone sequence 308.

In another example as shown in FIG. 24, the N_{pad} dummy tones may be padded to the end of the initial usable-tone sequence such that the last N_{pad} elements of the first usable-tone sequence 306 correspond to the N_{pad} dummy tones. After interleaving, the N_{pad} dummy tones are distributed in the second usable-tone sequence 308.

In yet another example as shown in FIG. 25, the N_{pad} dummy tones may be padded to the initial usable-tone sequence such that the first N_{pad} elements of the second usable-tone sequence 308 correspond to the N_{pad} dummy tones. This may be achieved by interleaving the sequence indices n=0, . . . , N−1 without setting the values of the first usable-tone sequence. Once k(n) are obtained, the elements sₙ₍ₖ₌₀₎, . . . , s_{n(k=N}_{_{pad}}₋₁₎ of the first usable-tone sequence 306 are set as the N_{pad} dummy tones, and other elements of the first usable-tone sequence 306 are used for the usable tones. In this example, the N_{pad} dummy tones are distributed in the first usable-tone sequence 306.

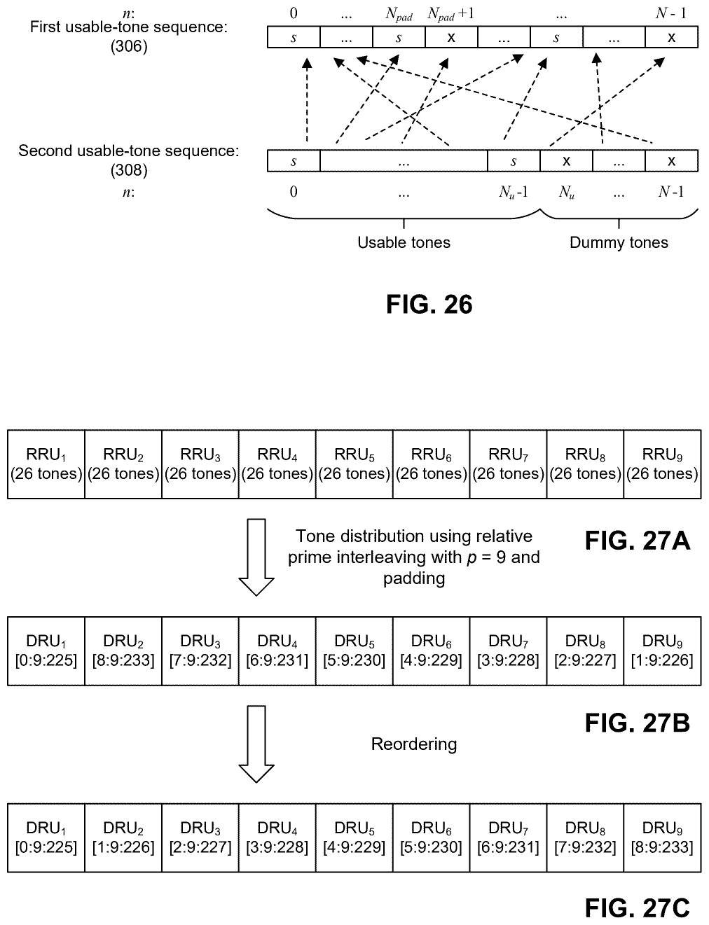

In still another example as shown in FIG. 26, the N_{pad} dummy tones may be padded to the initial usable-tone sequence such that the last N_{pad} elements of the second usable-tone sequence 308 correspond to the N_{pad} dummy tones.

FIG. 27A is a schematic diagram showing an example of a 20 MHz OFDMA PPDU having 234 usable tones (that is, Nᵤ=234) partitioned into nine (9) RRUs each having 26 tones.

FIG. 27B is a schematic diagram showing an example of the 20 MHz OFDMA PPDU having 234 usable tones partitioned into nine (9) DRUs each having 26 tones, obtained using the DRU-design procedure 300 shown in FIG. 22, wherein the relative prime interleaver uses a tone separation of p=9.

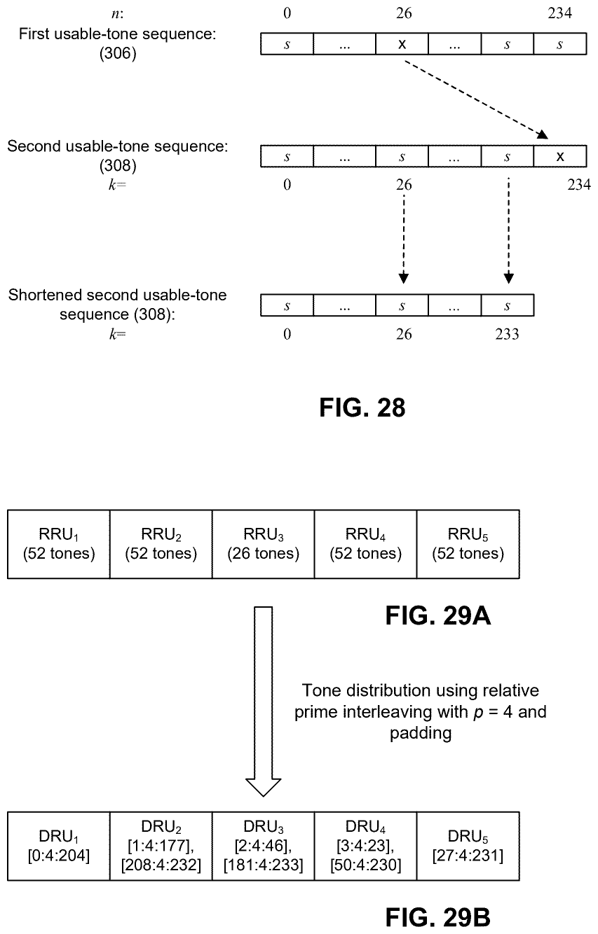

As p is not a relative prime of Nᵤ=234, the initial usable-tone sequence is padded with one dummy tone. Therefore, the length of the first usable-tone sequence 306 is N=235 (with indices n=0, . . . , 234), wherein the dummy tone is inserted at index n=26. After shuffling, the DRUs are arranged into nine (9) DRUs each having 26 tones by sequentially selecting tones from the second usable-tone sequence 308, wherein the dummy tone (which is interleaved to the index k(26)=234) is skipped or otherwise omitted during the DRU arrangement (that is, the dummy tone is effectively removed from the second usable-tone sequence 308; see FIG. 28). As shown in FIG. 27B, the tones in each DRU are uniformly distributed over 20 MHz PPDU BW with a tone separation of nine (9) as desired.

More specifically, the DRUs shown in FIG. 27B are:
DRU₁: [0:9:225];
DRU₂: [8:9:233];
DRU₃: [7:9:232];
DRU₄: [6:9:231];
DRU₅: [5:9:230];
DRU₆: [4:9:229];
DRU₇: [3:9:228];
DRU₈: [2:9:227]; and
DRU₉: [1:9:226].

In the DRU plan shown in FIG. 27B, the tones of “neighboring” DRUs are not “adjacent”. For example, DRU₁ has tones [0:9:225] but DRU₂ has tones [8:9:233]. On the other hand, the “adjacent” tones [0:9:225] and [1:9:226] belong to DRU₁ and DRU₉, respectively. Therefore, as shown in FIG. 27C, the DRUs shown in FIG. 27B may be reordered such that, after reordering, the tones of “neighboring” DRUs are “adjacent”.

More specifically, the DRUs shown in FIG. 27C are:
DRU₁: [0:9:225];
DRU₂: [1:9:226].
DRU₃: [2:9:227];
DRU₄: [3:9:228];
DRU₅: [4:9:229];
DRU₆: [5:9:230];
DRU₇: [6:9:231];
DRU₈: [7:9:232]; and
DRU₉: [8:9:233].

FIG. 29A is a schematic diagram showing an example of a 20 MHz OFDMA PPDU having 234 usable tones (that is, Nᵤ=234) partitioned into four (4) 52-tone RRUs and one (1) 26-tone RRU (at the center with two 52-tone RRUs on each side thereof).

FIG. 29B is a schematic diagram showing an example of the 20 MHz OFDMA PPDU having 234 usable tones partitioned into four (4) 52-tone DRUs and one (1) 26-tone DRU, obtained using the DRU-design procedure 300 shown in FIG. 22, wherein the relative prime interleaver uses a tone separation of p=4.

As p is not a relative prime of Nᵤ=234, the initial usable-tone sequence is padded with one dummy tone, and the length of the first usable-tone sequence 306 is N=235 (with indices n=0, . . . , 234), wherein the dummy tone is inserted at index n=176. After shuffling, the DRUs are arranged into four (4) 52-tone DRUs and one (1) 26-tone DRU by sequentially selecting tones from the second usable-tone sequence 308, wherein the dummy tone (which is interleaved to the index k(176)=234) is skipped or otherwise omitted during the DRU arrangement. As shown in FIG. 29B, the tones in each DRU are uniformly distributed over 20 MHz PPDU BW with a tone separation of four (4) as desired.

More specifically, the DRUs shown in FIG. 29B are:
DRU₁: [0:4:204];
DRU₂: [1:4:177] and [208:4:232];
DRU₃: [2:4:46] and [181:4:233];
DRU₄: [3:4:23] and [50:4:230]; and
DRU₅: [27:4:231].

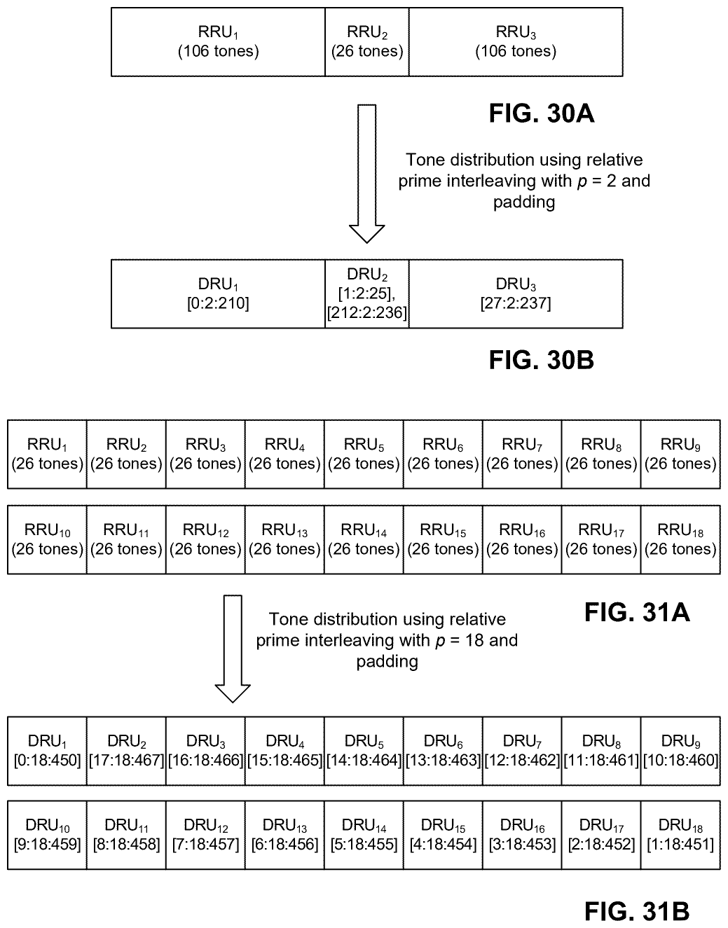

FIG. 30A is a schematic diagram showing an example of a 20 MHz OFDMA PPDU having 238 usable tones (that is, Nᵤ=238) partitioned into two (2) 106-tone RRUs and one (1) 26-tone RRU (at the center with one 106-tone RRU on each side thereof).

FIG. 30B is a schematic diagram showing an example of the 20 MHz OFDMA PPDU having 238 usable tones partitioned into two (2) 106-tone DRUs and one (1) 26-tone DRU, obtained using the DRU-design procedure 300 shown in FIG. 22, wherein the relative prime interleaver uses a tone separation of p=2.

As p is not a relative prime of Nᵤ=238, the initial usable-tone sequence is padded with one dummy tone, and the length of the first usable-tone sequence 306 is N=239 (with indices n=0, . . . , 238), wherein the dummy tone is inserted at index n=119. After shuffling, the DRUs are arranged into two (2) 106-tone DRUs and one (1) 26-tone DRU by sequentially selecting tones from the second usable-tone sequence 308, wherein the dummy tone (which is interleaved to the index k(119)=238) is skipped or otherwise omitted during the DRU arrangement. As shown in FIG. 30B, the tones in each DRU are uniformly distributed over 20 MHz PPDU BW with a tone separation of two (2) as desired.

More specifically, the DRUs shown in FIG. 30B are:
DRU₁: [0:2:210];
DRU₂: [1:2:25] and [212:2:236]; and
DRU₃: [27:2:237].

FIG. 31A is a schematic diagram showing an example of a 40 MHz OFDMA PPDU having 468 usable tones (that is, Nᵤ=468) partitioned into 18 RRUs each having 26 tones.

FIG. 31B is a schematic diagram showing an example of the 40 MHz OFDMA PPDU having 468 usable tones partitioned into 18 DRUs each having 26 tones, obtained using the DRU-design procedure 300 shown in FIG. 22, wherein the relative prime interleaver uses a tone separation of p=18.

As p is not a relative prime of Nᵤ=468, the initial usable-tone sequence is padded with one dummy tone, and the length of the first usable-tone sequence 306 is N=469 (with indices n=0, . . . , 468), wherein the dummy tone is inserted at index n=26. After shuffling, the DRUs are arranged into 18 DRUs each having 26 tones by sequentially selecting tones from the second usable-tone sequence 308, wherein the dummy tone (which is interleaved to the index k(26)=468) is skipped or otherwise omitted during the DRU arrangement. As shown in FIG. 31B, the tones in each DRU are uniformly distributed over 40 MHz PPDU BW with a tone separation of 18 as desired.

More specifically, the DRUs shown in FIG. 31B are:
DRU₁: [0:18:450];
DRU₂: [17:18:467];
DRU₃: [16:18:466];
DRU₄: [15:18:465];
DRU₅: [14:18:464];
DRU₆: [13:18:463];
DRU₇: [12:18:462];
DRU₈: [11:18:461];
DRU₉: [10:18:460];
DRU₁₀: [9:18:459];
DRU₁₁: [8:18:458];
DRU₁₂: [7:18:457];
DRU₁₃: [6:18:456];
DRU₁₄: [5:18:455];
DRU₁₅: [4:18:454];
DRU₁₆: [3:18:453];
DRU₁₇: [2:18:452]; and
DRU₁₈: [1:18:451].

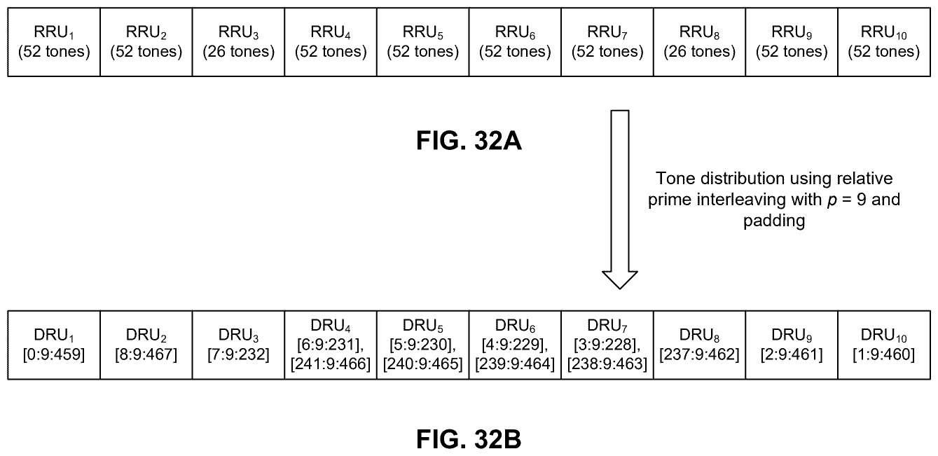

FIG. 32A is a schematic diagram showing an example of a 40 MHz OFDMA PPDU having 468 usable tones (that is, Nᵤ=468) partitioned into eight (8) RRUs each having 52 tones and two (2) RRUs each having 26 tones.

FIG. 32B is a schematic diagram showing an example of the 40 MHz OFDMA PPDU having 468 usable tones partitioned into eight (8) DRUs each having 52 tones and two (2) DRUs each having 26 tones, obtained using the DRU-design procedure 300 shown in FIG. 22, wherein the relative prime interleaver uses a tone separation of p=9.

As p is not a relative prime of Nᵤ=468, the initial usable-tone sequence is padded with one dummy tone, and the length of the first usable-tone sequence 306 is N=469 (with indices n=0, . . . , 468), wherein the dummy tone is inserted at index n=52. After shuffling, the DRUs are arranged into eight (8) 52-tone DRUs and two (2) 26-tone DRUs by sequentially selecting tones from the second usable-tone sequence 308, wherein the dummy tone (which is interleaved to the index k(52)=468) is skipped or otherwise omitted during the DRU arrangement. As shown in FIG. 32B, the tones in each DRU are uniformly distributed over 40 MHz PPDU BW with a tone separation of nine (9) as desired.

More specifically, the DRUs shown in FIG. 32B are:
DRU₁: [0:9:459];
DRU₂: [8:9:467];
DRU₃: [7:9:232];
DRU₄: [6:9:231] and [241:9:466];
DRU₅: [5:9:230] and [240:9:465];
DRU₆: [4:9:229] and [239:9:464];
DRU₇: [3:9:228] and [238:9:463];
DRU₈: [237:9:462];
DRU₉: [2:9:461]; and
DRU₁₀: [1:9:460].

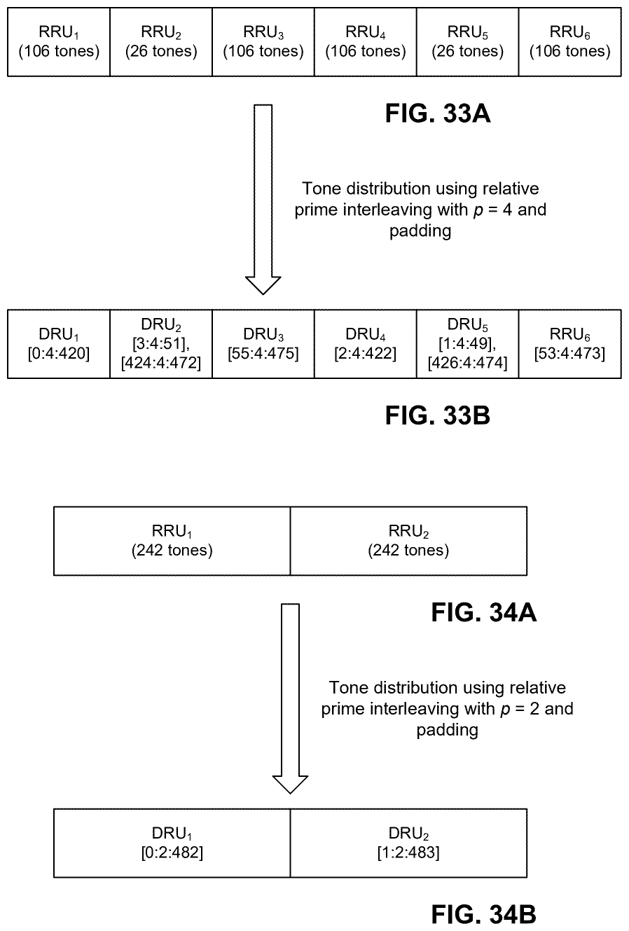

FIG. 33A is a schematic diagram showing an example of a 40 MHz OFDMA PPDU having 476 usable tones (that is, Nᵤ=476) partitioned into four (4) RRUs each having 106 tones and two (2) RRUs each having 26 tones.

FIG. 33B is a schematic diagram showing an example of the 40 MHz OFDMA PPDU having 476 usable tones partitioned into four (4) DRUs each having 106 tones and two (2) DRUs each having 26 tones, obtained using the DRU-design procedure 300 shown in FIG. 22, wherein the relative prime interleaver uses a tone separation of p=4.

As p is not a relative prime of Nᵤ=476, the initial usable-tone sequence is padded with one dummy tone, and the length of the first usable-tone sequence 306 is N=477 (with indices n=0, . . . , 476), wherein the dummy tone is inserted at index n=119. After shuffling, the DRUs are arranged into four (4) 106-tone DRUs and two (2) 26-tone DRUs by sequentially selecting tones from the second usable-tone sequence 308, wherein the dummy tone (which is interleaved to the index k(119)=476) is skipped or otherwise omitted during the DRU arrangement. As shown in FIG. 33B, the tones in each DRU are uniformly distributed over 40 MHz PPDU BW with a tone separation of four (4) as desired.

More specifically, the DRUs shown in FIG. 33B are:
DRU₁: [0:4:420];
DRU₂: [3:4:51] and [424:4:472];
DRU₃: [55:4:475];
DRU₄: [2:4:422];
DRU₅: [1:4:49] and [426:4:474];
DRU₆: [53:4:473].

FIG. 34A is a schematic diagram showing an example of a 40 MHz OFDMA PPDU having 484 usable tones (that is, Nᵤ=484) partitioned into two (2) RRUs each having 242 tones.

FIG. 34B is a schematic diagram showing an example of the 40 MHz OFDMA PPDU having 484 usable tones partitioned into two (2) DRUs each having 242 tones, obtained using the DRU-design procedure 300 shown in FIG. 22, wherein the relative prime interleaver uses a tone separation of p=2.

As p is not a relative prime of Nᵤ=484, the initial usable-tone sequence is padded with one dummy tone, and the length of the first usable-tone sequence 306 is N=485 (with indices n=0, . . . , 484), wherein the dummy tone is inserted at index n=242. After shuffling, the DRUs are arranged into two (2) 242-tone DRUs by sequentially selecting tones from the second usable-tone sequence 308, wherein the dummy tone (which is interleaved to the index k(242)=484) is skipped or otherwise omitted during the DRU arrangement. As shown in FIG. 34B, the tones in each DRU are uniformly distributed over 40 MHz PPDU BW with a tone separation of two (2) as desired.

More specifically, the DRUs shown in FIG. 34B are:
DRU₁: [0:2:482]; and
DRU₂: [1:2:483].

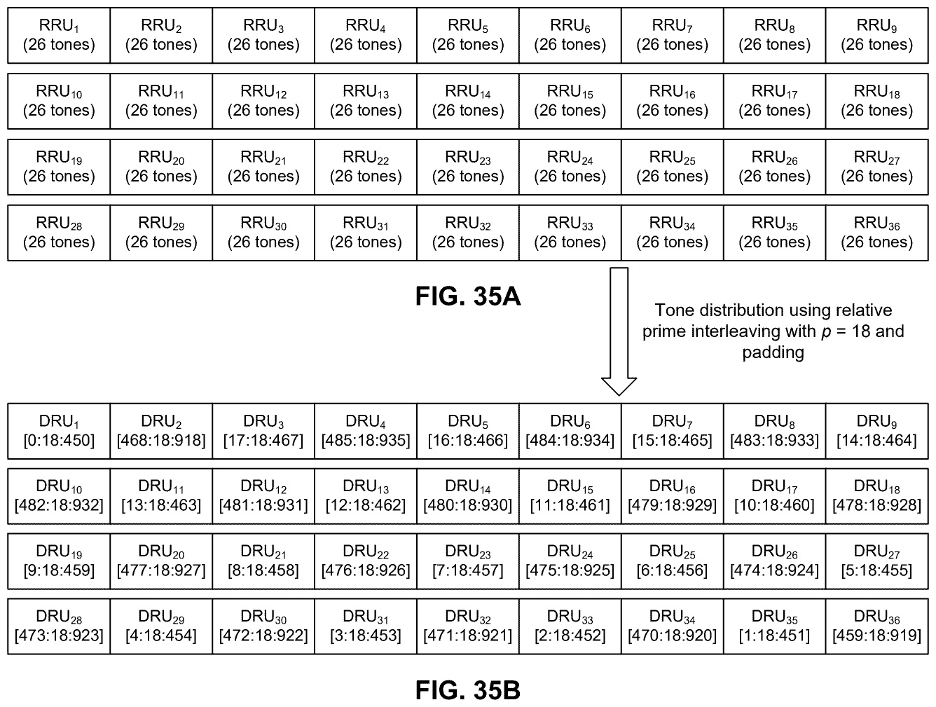

FIG. 35A is a schematic diagram showing an example of an 80 MHz OFDMA PPDU having 936 usable tones (that is, Nᵤ=936) partitioned into 36 RRUs each having 26 tones.

FIG. 35B is a schematic diagram showing an example of the 80 MHz OFDMA PPDU having 936 usable tones partitioned into 36 DRUs each having 26 tones, obtained using the DRU-design procedure 300 shown in FIG. 22, wherein the relative prime interleaver uses a tone separation of p=18.

As p is not a relative prime of Nᵤ=936, the initial usable-tone sequence is padded with one dummy tone, and the length of the first usable-tone sequence 306 is N=937 (with indices n=0, . . . , 936), wherein the dummy tone is inserted at index n=52. After shuffling, the DRUs are arranged into 36 DRUs each having 26 tones by sequentially selecting tones from the second usable-tone sequence 308, wherein the dummy tone (which is interleaved to the index k(52)=936) is skipped or otherwise omitted during the DRU arrangement. As shown in FIG. 35B, the tones in each DRU are uniformly distributed over 80 MHz PPDU BW with a tone separation of 18 as desired.

More specifically, the DRUs shown in FIG. 35B are:
DRU₁: [0:18:450];
DRU₂: [468:18:918];
DRU₃: [17:18:467];
DRU₄: [485:18:935];
DRU₅: [16:18:466];
DRU₆: [484:18:934];
DRU₇: [15:18:465];
DRU₈: [483:18:933];
DRU₉: [14:18:464];
DRU₁₀: [482:18:932];
DRU₁₁: [13:18:463];
DRU₁₂: [481:18:931];
DRU₁₃: [12:18:462];
DRU₁₄: [480:18:930];
DRU₁₅: [11:18:461];
DRU₁₆: [479:18:929];
DRU₁₇: [10:18:460];
DRU₁₈: [478:18:928];
DRU₁₉: [9:18:459];
DRU₂₂: [476:18:926];
DRU₂₀: [477:18:927];
DRU₂₁: [8:18:458];
DRU₂₃: [7:18:457];
DRU₂₇: [5:18:455];
DRU₂₄: [475:18:925];
DRU₂₅: [6:18:456];
DRU₂₆: [474:18:924];
DRU₂₈: [473:18:923];
DRU₂₉: [4:18:454];
DRU₃₀: [472:18:922];
DRU₃₁: [3:18:453];
DRU₃₂: [471:18:921];
DRU₃₃: [2:18:452];
DRU₃₄: [470:18:920];
DRU₃₅: [1:18:451]; and
DRU₃₆: [459:18:919].

FIG. 36A is a schematic diagram showing an example of an 80 MHz OFDMA PPDU having 936 usable tones (that is, Nᵤ=936) partitioned into 16 RRUs each having 52 tones and four (4) RRUs each having 26 tones.

FIG. 36B is a schematic diagram showing an example of the 80 MHz OFDMA PPDU having 936 usable tones partitioned into 16 DRUs each having 52 tones and four (4) DRUs each having 26 tones, obtained using the DRU-design procedure 300 shown in FIG. 22, wherein the relative prime interleaver uses a tone separation of p=18.

As p is not a relative prime of Nᵤ=936, the initial usable-tone sequence is padded with one dummy tone, and the length of the first usable-tone sequence 306 is N=937 (with indices n=0, . . . , 936), wherein the dummy tone is inserted at index n=52. After shuffling, the DRUs are arranged into 16 DRUs each having 52 tones and four (4) DRUs each having 26 tones by sequentially selecting tones from the second usable-tone sequence 308, wherein the dummy tone (which is interleaved to the index k(52)=936) is skipped or otherwise omitted during the DRU arrangement. As shown in FIG. 36B, the tones in each DRU are uniformly distributed over 80 MHz PPDU BW with a tone separation of 18 as desired.

More specifically, the DRUs shown in FIG. 36B are:
DRU₁: [0:18:918];
DRU₂: [17:18:935];
DRU₃: [16:18:466];
DRU₄: [15:18:465] and [484:18:934];
DRU₅: [14:18:464] and [483:18:933];
DRU₆: [13:18:463] and [482:18:932];
DRU₇: [12:18:462] and [481:18:931];
DRU₈: [480:18:930];
DRU₉: [11:18:929];
DRU₁₀: [10:18:928];
DRU₁₁: [9:18:927];
DRU₁₂: [8:18:926];
DRU₁₃: [7:18:457];
DRU₁₄: [6:18:546] and [475:18:925];
DRU₁₅: [5:18:455] and [474:18:924];
DRU₁₆: [4:18:454] and [473:18:923];
DRU₁₇: [3:18:453] and [472:18:822];
DRU₁₈: [471:18:921];
DRU₁₉: [2:18:920]; and
DRU₂₀: [1:18:919].

Alternatively, a 52-tone DRU may be obtained by combining two consecutive 26-tone DRUs.

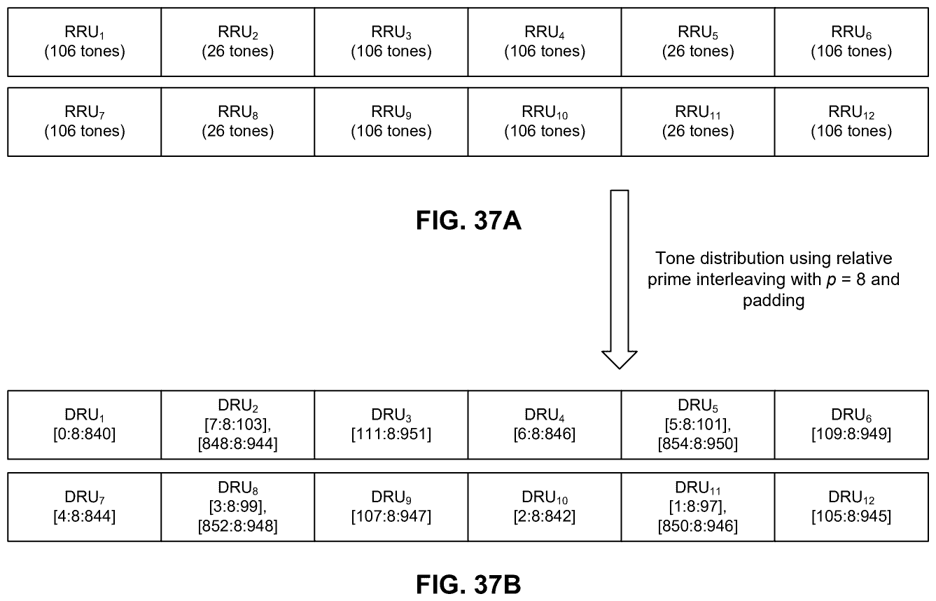

FIG. 37A is a schematic diagram showing an example of an 80 MHz OFDMA PPDU having 952 usable tones (that is, Nᵤ=952) partitioned into eight (8) RRUs each having 106 tones and four (4) RRUs each having 26 tones.

FIG. 37B is a schematic diagram showing an example of the 80 MHz OFDMA PPDU having 952 usable tones partitioned into eight (8) DRUs each having 106 tones and four (4) DRUs each having 26 tones, obtained using the DRU-design procedure 300 shown in FIG. 22, wherein the relative prime interleaver uses a tone separation of p=8.

As p is not a relative prime of Nᵤ=952, the initial usable-tone sequence is padded with one dummy tone, and the length of the first usable-tone sequence 306 is N=953 (with indices n=0, . . . , 952), wherein the dummy tone is inserted at index n=119. After shuffling, the DRUs are arranged into eight (8) DRUs each having 106 tones and four (4) DRUs each having 26 tones by sequentially selecting tones from the second usable-tone sequence 308, wherein the dummy tone (which is interleaved to the index k(119)=952) is skipped or otherwise omitted during the DRU arrangement. As shown in FIG. 37B, the tones in each DRU are uniformly distributed over 80 MHz PPDU BW with a tone separation of eight (8) as desired.

More specifically, the DRUs shown in FIG. 37B are:
DRU₁: [0:8:840];
DRU₂: [7:8:103] and [848:8:944];
DRU₃: [111:8:951];
DRU₄: [6:8:846];
DRU₅: [5:8:101] and [854:8:950];
DRU₆: [109:8:949];
DRU₇: [4:8:844];
DRU₈: [3:8:99] and [852:8:948];
DRU₉: [107:8:947];
DRU₁₀: [2:8:842];
DRU₁₁: [1:8:97] and [850:8:946]; and
DRU₁₂: [105:8:945].

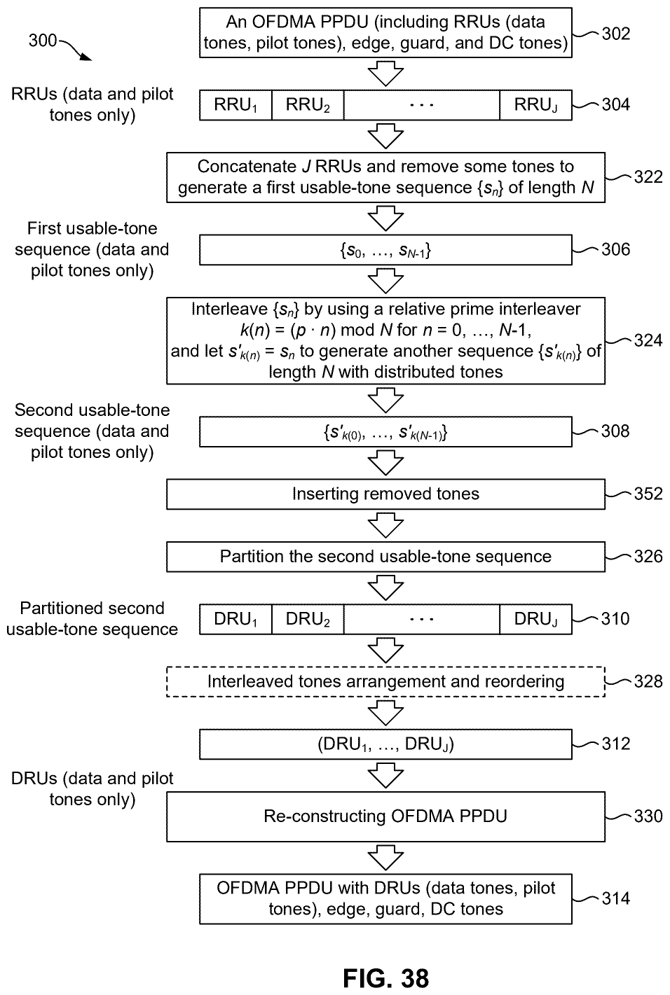

FIG. 38 is a flowchart showing the DRU-design procedure 300, according to some embodiments of this disclosure. The DRU-design procedure 300 is similar to that shown in FIG. 12 except the step 322 is different and a new step 352 is added, which will be described in more detail below.

In these embodiments, the tone separation p is not a relative prime of the number of usable tones, denoted

$${N}_{u} = {\sum }_{j = 1}^{J} {N}_{j} .$$

Therefore, at step 322, the first usable-tone sequence {sₙ} is obtained by concatenating the J RRUs 304 to form an initial usable-tone sequence, and removing Nₛₕₒᵣₜₑₙ tones from the end of the initial usable-tone sequence (that is, from the end of the last RRU) to obtain the first usable-tone sequence 306, such that the tone separation p is a relative prime of the length of the first usable-tone sequence {sₙ},

$$N = {\sum }_{j = 1}^{J} {N}_{j} - {N}_{shorten} .$$

Here, Nₛₕₒᵣₜₑₙ≥1 is the smallest integer that makes the tone separation p a relative prime of the length of the first usable-tone sequence {sₙ},

$$N = {\sum }_{j = 1}^{J} {N}_{j} - {N}_{shorten} .$$

At step 324 (which is the same as that shown in FIG. 12), the second usable-tone sequence {sₖ(n)} is obtained.

Then, the removed Nₛₕₒᵣₜₑₙ tones are inserted back to the second usable-tone sequence {sₖ′(n)} (step 352) to obtain an expanded second usable-tone sequence, such that the distance or spacing of the removed tone and the interleaved tone in {sₖ′} is at least p.

In many practical scenarios, Nₛₕₒᵣₜₑₙ=1 makes the tone separation p a relative prime of the length of the first usable-tone sequence {sₙ},

$$N = {\sum }_{j = 1}^{J} {N}_{j} - {N}_{shorten} .$$

Therefore, in some embodiments for these practical scenarios, the removed tone is simply added to the end of the second usable-tone sequence {sₖ₍ₙ₎′} to obtain the expanded second usable-tone sequence.

In some embodiments, Nₛₕₒᵣₜₑₙ≥1 is used. In other words, s_{N}_{ᵤ}_{-N}_{ₛₕₒᵣₜₑₙ}, . . . , s_{N}_{ᵤ}₋₁ are removed from the initial usable-tone sequence. In these embodiments, after shuffling the initial usable-tone sequence to obtain the second usable-tone sequence, the first tone of the Nₛₕₒᵣₜₑₙ tones, that is, s_{N}_{ᵤ}−Nₛₕₒᵣₜₑₙ, is added to the end of the second usable-tone sequence {sₖ₍ₙ₎′}. Then, each subsequent tone of the Nₛₕₒᵣₜₑₙ tones, that is, s_{N}_{ᵤ}−Nₛₕₒᵣₜₑₙ₊ᵢ, 0≤i<Nₛₕₒᵣₜₑₙ, is inserted to the location in the second usable-tone sequence {sₖ₍ₙ₎′} after sₖ′, where k′=Nᵤ−Nₛₕₒᵣₜₑₙ+i−p, to obtain the expanded second usable-tone sequence.

Then, the expanded second usable-tone sequence is partitioned into J DRUs (step 326, which is the same as that shown in FIG. 12). The rest of the procedure 300 (such as steps 328 and 330) are the same as those shown in FIG. 12.

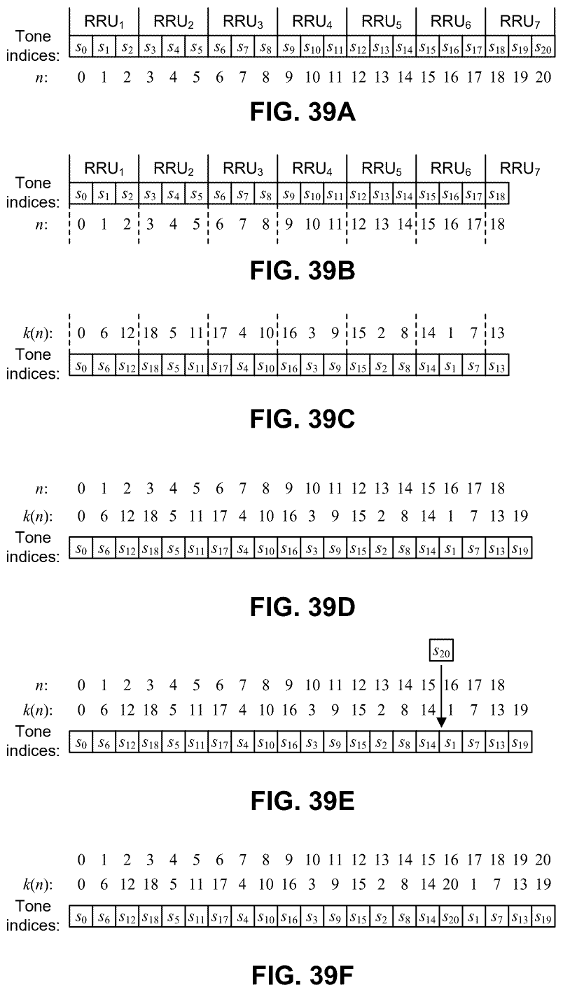

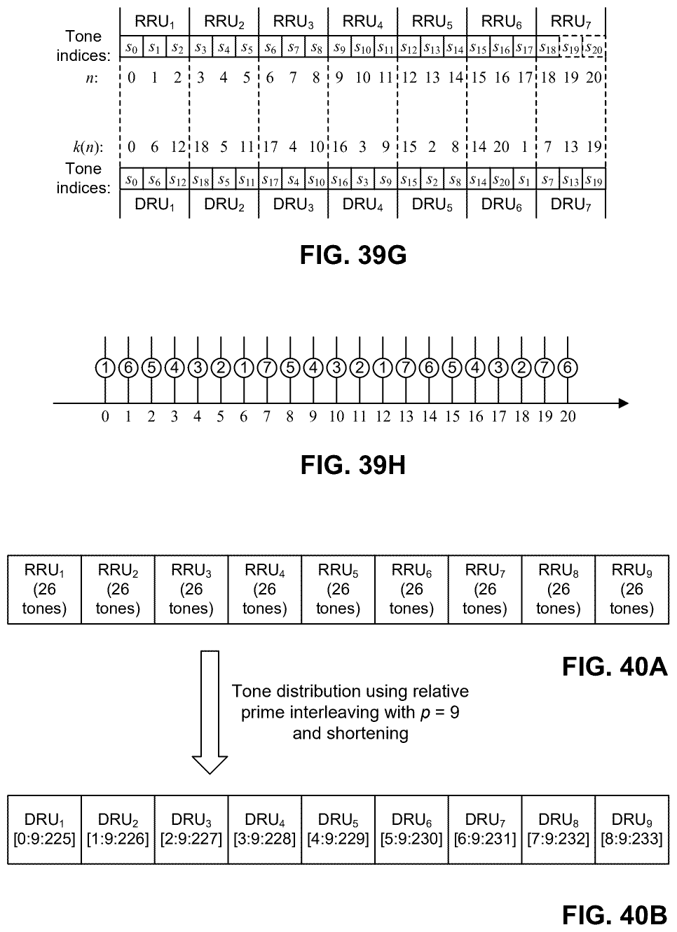

FIGS. 39A to 39H show an example (for illustrative purposes only, and may not be a real scenario). As shown in FIG. 39A, an OFDMA PPDU has 21 usable tones (that is, Nᵤ=21) partitioned into J=7 RRUs, RRU₁ to RRU₇, with each RRU having three (3) tones. The initial usable-tone sequence is s₀, . . . , s₂₀.

Now, a DRU plan is to be designed for this PPDU to partition the usable tones to seven (7) DRUs each corresponding to a respective RRU and having a tone separation p=6.

As shown in FIG. 39B, Nₛₕₒᵣₜₑₙ=2 tones (that is, s₁₉ and s₂₀) are removed from the initial usable-tone sequence, such that the first usable-tone sequence becomes s₀, . . . , s₁₈ having a length N=19, which is a relative prime of p=6.

As shown in FIG. 39C, the first usable-tone sequence is then shuffled using a relative prime interleaver to the second usable-tone sequence.

As shown in FIG. 39D, to add the removed tones back, the first removed tone s₁₉ (that is, index i=0 in the removed tones) is simply add to the end of the second usable-tone sequence, that is, after s₁₃.

As shown in FIG. 39E, the second removed tone s₂₀ (that is, index i=1 in the removed tones) is inserted to the location after k′=Nᵤ−Nₛₕₒᵣₜₑₙ+i−p=21−2+1−6=14, that is, between s₁₄ and s₁.

The expanded second usable-tone sequence is shown in FIG. 39F.

As shown in FIG. 39G, the expanded second usable-tone sequence is partitioned into J=7 DRUs in accordance with the seven (7) RRUs, as described above.

After reordering, the seven (7) DRUs are shown in FIG. 39H.

As those skilled in the art will appreciate, by using the DRU-design procedure 300 shown in FIG. 38, existing HE/EHT RU allocations and tone plans may be reused without any change, while tones in each RRU may be distributed with substantially equal tone separation in the corresponding DRU with desired tone separations. The DRUs maintain the same spectrum efficiency as RRUs specified in HE and EHT.

In some embodiments, the tone separation p is not a relative prime of the number of usable tones,

$${N}_{u} = {\sum }_{j = 1}^{J} {N}_{j} .$$

Therefore, at step 322, the first usable-tone sequence {sₙ} is obtained by concatenating the J RRUs 304 to form an initial usable-tone sequence, and removing Nₛₕₒᵣₜₑₙ tones from the end of the initial usable-tone sequence (that is, from the end of the last RRU) to obtain the first usable-tone sequence 306, where Nₛₕₒᵣₜₑₙ≥1 is an integer, such that:
the tone separation p is a relative prime of the length of the first usable-tone sequence {sₙ},

$$N = {\sum }_{j = 1}^{J} {N}_{j} - {N}_{shorten} ,$$

and

$$p \leq ⌈ N / ( max ( {N}_{j} ) ) ⌉ , j = 1 , … , J .$$

FIG. 40A is a schematic diagram showing an example of a 20 MHz OFDMA PPDU having 234 usable tones (that is, Nᵤ=234) partitioned into nine (9) RRUs each having 26 tones.

FIG. 40B is a schematic diagram showing an example of the 20 MHz OFDMA PPDU having 234 usable tones partitioned into nine (9) DRUs each having 26 tones, obtained using the DRU-design procedure 300 shown in FIG. 38, wherein the relative prime interleaver uses a tone separation of p=9.

As p is not a relative prime of Nᵤ=234, the initial usable-tone sequence is shortened by removing the last tone s₂₃₃. Thus, the first usable-tone sequence 306 comprises tones s₀, . . . , s₂₃₂ with a length of N=233, which is a relative prime of p=9.

The first usable-tone sequence is shuffled using the relative prime interleaver to obtain the second usable-tone sequence, which is expanded by adding the removed tone s₂₃₃ to the end thereof. As shown in FIG. 40B, the tones in each DRU are uniformly distributed over 20 MHz PPDU BW with a tone separation of nine (9) as desired.

More specifically, the DRUs shown in FIG. 40B are:
DRU₁: [0:9:225];
DRU₂: [1:9:226].
DRU₃: [2:9:227];
DRU₄: [3:9:228];
DRU₅: [4:9:229];
DRU₆: [5:9:230];
DRU₇: [6:9:231];
DRU₈: [7:9:232]; and
DRU₉: [8:9:233].

As can be seen, this DRU plan is the same as that shown in FIG. 27C.

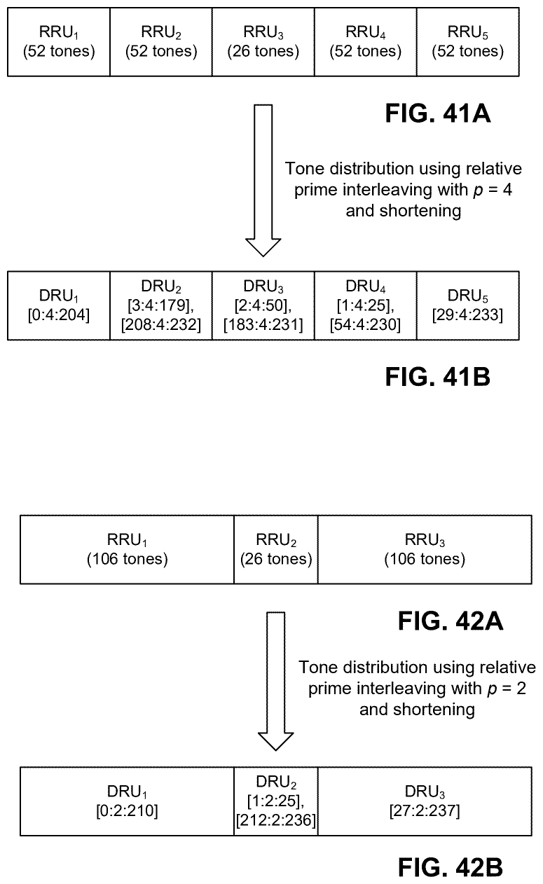

FIG. 41A is a schematic diagram showing an example of a 20 MHz OFDMA PPDU having 234 usable tones (that is, Nᵤ=234) partitioned into four (4) 52-tone RRUs and one (1) 26-tone RRU (at the center with two 52-tone RRUs on each side thereof).

FIG. 41B is a schematic diagram showing an example of the 20 MHz OFDMA PPDU having 234 usable tones partitioned into four (4) 52-tone DRUs and one (1) 26-tone DRU, obtained using the DRU-design procedure 300 shown in FIG. 38, wherein the relative prime interleaver uses a tone separation of p=4.

As p is not a relative prime of Nᵤ=234, the initial usable-tone sequence is shortened by removing the last tone s₂₃₃. Thus, the first usable-tone sequence 306 comprises tones s₀, . . . , s₂₃₂ with a length of N=233, which is a relative prime of p=4.

The first usable-tone sequence is shuffled using the relative prime interleaver to obtain the second usable-tone sequence, which is expanded by adding the removed tone s₂₃₃ to the end thereof. As shown in FIG. 41B, the tones in each DRU are uniformly distributed over 20 MHz PPDU BW with a tone separation of four (4) as desired. That is, the DRUs shown in FIG. 41B are:
DRU₁: [0:4:204];
DRU₂: [3:4:179] and [208:4:232];
DRU₃: [2:4:50] and [183:4:231];
DRU₄: [1:4:25] and [54:4:230]; and
DRU₅: [29:4:233].

FIG. 42A is a schematic diagram showing an example of a 20 MHz OFDMA PPDU having 238 usable tones (that is, Nᵤ=238) partitioned into two (2) 106-tone RRUs and one (1) 26-tone RRU (at the center with one 106-tone RRU on each side thereof).

FIG. 42B is a schematic diagram showing an example of the 20 MHz OFDMA PPDU having 238 usable tones partitioned into two (2) 106-tone DRUs and one (1) 26-tone DRU, obtained using the DRU-design procedure 300 shown in FIG. 38, wherein the relative prime interleaver uses a tone separation of p=2.

As p is not a relative prime of Nᵤ=234, the initial usable-tone sequence is shortened by removing the last tone s₂₃₇. Thus, the first usable-tone sequence 306 comprises tones s₀, . . . , s₂₃₆ with a length of N=237, which is a relative prime of p=2.

The first usable-tone sequence is shuffled using the relative prime interleaver to obtain the second usable-tone sequence, which is expanded by adding the removed tone s₂₃₇ to the end thereof. As shown in FIG. 42B, the tones in each DRU are uniformly distributed over 20 MHZ PPDU BW with a tone separation of two (2) as desired. That is, the DRUs shown in FIG. 42B are:
DRU₁: [0:2:210];
DRU₂: [1:2:25] and [212:2:236]; and
DRU₃: [27:2:237].

As can be seen, this DRU plan is the same as that shown in FIG. 30B.

In above embodiments, DRU-design methods using relative prime interleavers and the DRU plans are described. The DRU-design methods disclosed herein may be used to generate DRUs 308 of suitable sizes and desired tone separations. The DRU-design methods disclosed herein generally use a relative prime interleaver (with the desired tone separation as a parameter) to interleave, shuffle, or otherwise reorder the indices of a first usable-tone sequence which comprises the usable tones of a PPDU (wherein the indices of the first usable-tone sequence are for the usable tones only, which, therefore, may be different to the indices of the usable tones in the PPDU).

The relative prime interleaver requires that the tone separation p is a relative prime of the length N of the first usable-tone sequence. In some embodiments wherein p is not a relative prime of N, sequence padding (that is, adding some dummy tones) or sequence shortening (that is, removing some tones) may be used to adjust the length N of the first usable-tone sequence to make N a relative prime of p. After interleaving, the dummy tones (if sequence padding is used) are removed from interleaved, shuffled, or otherwise reordered usable-tone sequence (that is, the second usable-tone sequence), or the removed tones (if sequence shortening is used) are added back to the second usable-tone sequence.

The usable-tone sequence is then partitioned into a plurality of DRUs. In some embodiments, the partitioning of the DRUs may reference to a corresponding RRU plan (that is, an RRU plan having the same number of RRUs as the number of DRUs, and the sizes of the RRUs are the same as those of the DRUs, although the tones in each RRU are different to the tones in the corresponding DRU).

As described above, in some embodiments, the partitioning of the DRUs may be performed based on the requirements (such as the number of DRUs, or numbers of DRUs of different sizes), and without referencing to any RRU plan.

In some embodiments, a general framework of a DRU plan may be designed based on the maximum number of tones N and a desired tone separation p.

In these embodiments, the first portion of the DRU-design procedure shown in FIG. 12 (steps 322 to 324), FIG. 16 (steps 322 to 324), FIG. 22 (step 322 to 342), or FIG. 38 (steps 322 to 352) may be used to generate the general framework of a DRU plan comprising interleaved tone indices obtained from the second usable-tone sequence, or equivalently, represented by the second usable-tone sequence. Similar to the description above, reference to RRUs may or may not be used.

In some embodiments, the general framework may be predefined or preconfigured.

When a specific or complete DRU plan (that is, a DRU plan having all DRUs defined) is needed, it may be obtained by partitioning the general framework (for example, the second usable-tone sequence) into a plurality of required DRUs as described above (for example, following steps 326 to 330 in FIG. 12, 16, 22, or 38). In some embodiments, the generation of the specific or complete DRU plan from the general framework may be performed as needed and/or in real-time.

For example, in a 20 MHz PPDU, the maximum number of tones N for different RU settings in an OFDMA PPDU can be determined based on Table 27-27 IEEE P802.11-REVme/D4.1, for example:
234 usable tones (partitioned into nine (9) 26-tone RUs with the largest RU size being 26, or partitioned into four (4) 52-tone RUs and one 26-tone RU with the largest RU size being 52);
238 usable tones (partitioned into two (2) 106-tone RUs and one 26-tone RU with the largest RU size being 106).

As an example, a general framework of a DRU plan with a tone separation p=9 (which is applicable for any combinations of multiplexed DRUs of size 26-tone) for a PPDU having 234 usable tones as shown in Table 27-27 RU Allocation subfield in IEEE P802.11-REVme/D4.1 may be designed using relative prime interleaving with shortening as described above. The indices of the first usable-tone sequence are [0:233] with a length of 234. After relative prime interleaving, the indices of the second usable-tone sequence of length 234 is [0:9:225, 1:9:226, 2:9:227, 3:9:228, 4:9:229, 5:9:230, 6:9:231, 7:9:232, 8:9:233]. The general framework may be represented by the second usable-tone sequence.

When a specific or complete DRU plan (for example, having nine (9) 26-tone DRUs) is needed, the general framework (that is, the second usable-tone sequence) is partitioned into required number of DRUs as described above (for example, following step 326 to 330 in FIG. 12 or 16) to obtain the DRU plan as shown in FIG. 27C.

As another example, a general framework of a DRU plan with a tone separation of p=4 (which is applicable for any combinations of DRUs of size 52-tone and 26-tone) for a PPDU having 234 usable tones as shown in Table 27-27 RU Allocation subfield in IEEE P802.11-REVme/D4.1 may be designed using the relative prime interleaving with shortening as described above. The indices of the first usable-tone sequence are [0:233] with a length of 234. After relative prime interleaving, the indices of the second usable-tone sequence of length 234 is [0:4:232, 3:4:231, 2:4:230, 1:4:233]. The general framework may be represented by the second usable-tone sequence.

When a specific or complete DRU plan (for example, having four (4) 52-tone DRUs and one 26-tone DRU) is needed, the general framework (that is, the second usable-tone sequence) is partitioned into required number of DRUs as described above to obtain the DRU plan as shown in FIG. 41B.

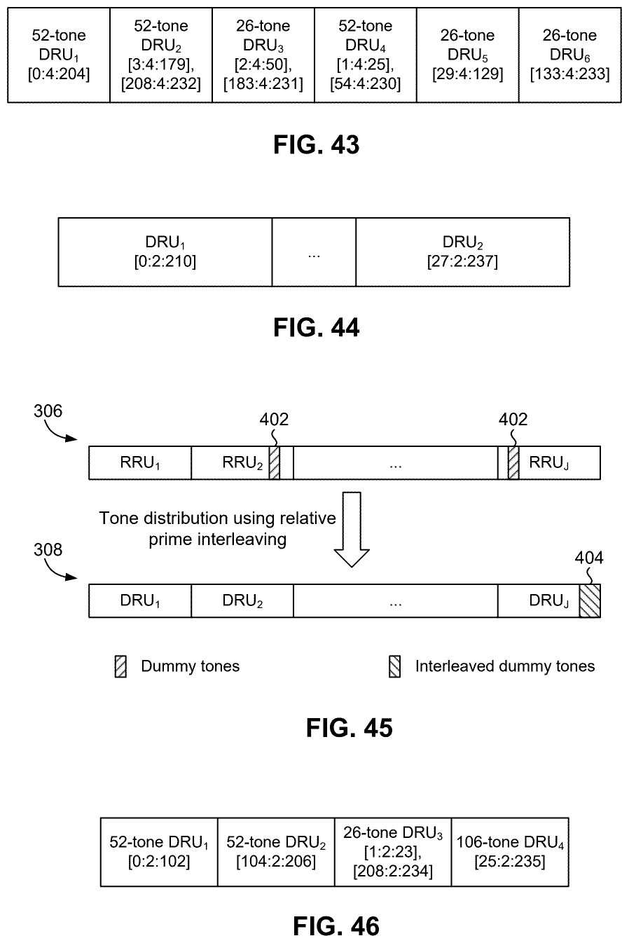

As another example, when needed, the general framework is partitioned into three (3) 52-tone DRUs and three (3) 26-tone DRUs to obtain a specific DRU plan as shown in FIG. 43.

Alternatively, this DRU plan may be obtained by splitting the DRUs in the DRU plan shown in FIG. 41B into two non-overlapping 26-tone DRUs.

Similarly, a general framework of a DRU plan with a tone separation of p=2 (which is applicable for any combinations of DRUs of sizes 106-tone and/or 26-tone) for a PPDU having 238 usable tones as shown in Table 27-27 RU Allocation subfield in IEEE P802.11-REVme/D4.1 may be designed using the relative prime interleaving with shortening as described above. The indices of the first usable-tone sequence are [0:237] with a length of 238. After relative prime interleaving, the indices of the second usable-tone sequence of length 234 is [0:2:236, 1:2:237]. The general framework may be represented by the second usable-tone sequence.

When a specific DRU plan (for example, at least having two 106-tone DRUs) is needed, two 106-tone DRUs, DRU₁ and DRU₂ may be obtained from the general framework (that is, the second usable-tone sequence) as shown in FIG. 44.

In some embodiments, a general framework of a DRU plan for a PPDU having a maximum number of usable tones (for example, N=238) with a specific tone separation (for example, p=2) is predefined or preconfigured, which may be used to generate a specific DRU plan with the same tone separation (that is, p=2) but a smaller number of usable tones, which is applicable for any combinations of DRUs of sizes 106-tone, 52-tone, and/or 26-tone when there is only one 106-tone DRU, and for example, the maximum number of tones in the RRU sequence is 236 (for example, 106+5×26).

As shown in FIG. 45, to generate a specific DRU plan, the general frame or the second usable-tone sequence 308 may be considered to have two dummy tones 402 to be located at the indices of 118 and 237 in the first usable-tone sequence 306 with indices [0:237], which are interleaved to indices of 236 and 237, respectively (indicated as interleaved dummy tones 404), in the second usable-tone sequence 308, which are discarded before generating the DRUs. In other words, —before interleaving, the length of the first usable-tone sequence with inserted two dummy tones is 238 with indices as [0:237]. After interleaving and removing the two dummy tones, the indices of the shortened second usable-tone sequence of length 236 is [0:2:234, 1:2:235].

For example, FIG. 46 shows the generated DRU plan having one (1) 106-tone DRU, two (2) 52-tone DRUs, and one 26-tone DRU with a tone separation p=2, for an OFDMA 20 MHZ PPDU including following RUs as shown in Table 27-27 RU Allocation subfield in IEEE P802.11-REVme/D4.1.

Those skilled in the art will appreciate that the DRU-design methods disclosed herein (including the methods for generating the general framework and the methods for obtaining a specific DRU plan) are not limited to DRU design for an OFDMA 20 MHz PPDU. Rather, the DRU-design methods disclosed herein may be readily used for DRU design for an OFDMA PPDU with other BWs such as 40 MHz, 80 MHz, 160 MHz, and 320 MHz.

In some embodiments, one may use the DRU-design methods disclosed herein to design DRUs for an OFDMA 20 MHz PPDU, and repeat the obtained DRUs for a suitable number of times to obtain DRUs for an OFDMA PPDU with a BW that is a multiple of 20 MHz (such as 40, 80, 160, or 320 MHz).

In some embodiments, one may use the DRU-design methods disclosed herein to design DRUs for an OFDMA 20 MHz PPDU, and allocate the obtained DRUs to a 20 MHz spectrum portion in a larger BW (such as 40 MHz, 80 MHz, 160 MHz or 320 MHz) PPDU. In these embodiments, the rest of BW may be used for RRUs (that is, only a portion of BW is used for DRUs).

As those skilled in the art understand, IEEE 802.11be includes assigning multiple resource units (MRUs) to a single user. For example, in 802.11be, a user may be assigned with a 52+26-tone MRU which combines a 52-tone RU and an adjacent 26-tone RU (which are RRUs), or assigned with a 106+26-tone MRU which combines a 106-tone RU and an adjacent 26-tone RU (which are RRUs).

The indices for small size MRUs in an OFDMA 20, 40, or 80 MHZ EHT PPDU are defined in Tables 36-8, 36-9 and 36-10 in 802.11be, respectively.

In some embodiments, multiple DRUs (M-DRUs) may be designed and used as MRUs for the same purpose.

For example, tone distribution of M-DRUs in an OFDMA 20 MHz PPDU may be obtained based on above-described DRUs and by combining a 26-tone DRU and a 52-tone DRU to generate a 52+26-tone M-DRU, or combining a 26-tone DRU and a 106-tone DRU to generate a 106+26-tone M-DRU within the same BW PPDU.

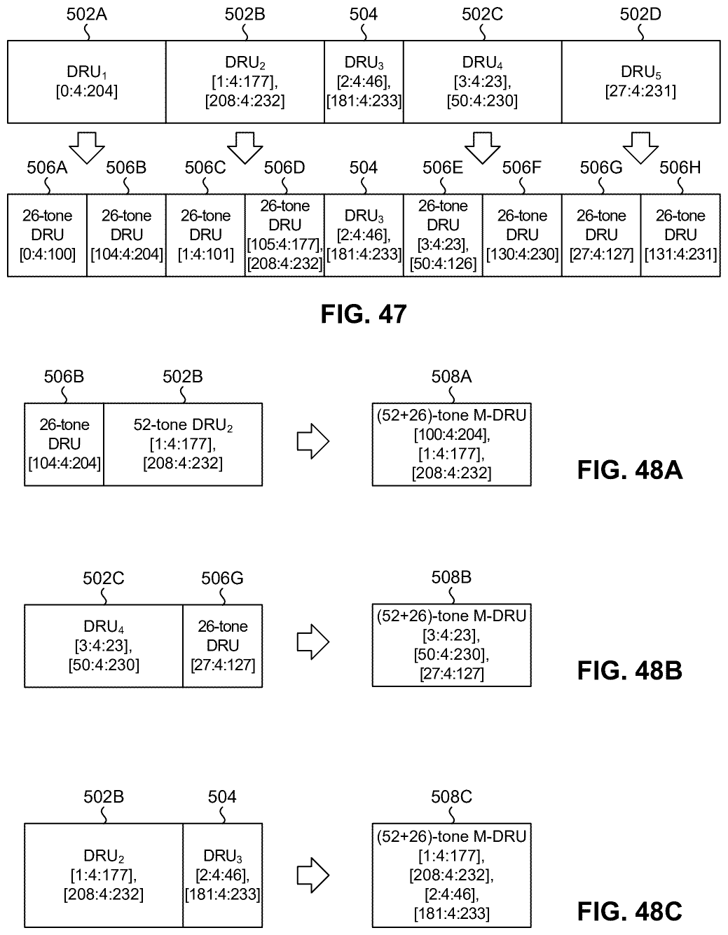

For example, the tone distribution in a 52+26-tone M-DRU may be obtained based on the DRU plan shown in FIG. 29B having four (4) 52-tone DRUs and one 26-tone DRU, and by the following steps:
Step 1: As shown in FIG. 47, splitting each larger-size DRU (for example, each of the four (4) 52-tone DRUs 502) to a plurality of non-overlapping or non-interleaved smaller-size DRUs (for example, two non-overlapping or non-interleaved 26-tone DRUs 506). Here, each pair of non-overlapping or non-interleaved DRUs refer to two DRUs wherein the frequencies of the tones in one DRU is smaller than the frequency of any tone in the other DRU. For ease of description, the 52-tone DRU 502 is denoted a parent 52-tone DRU and the two 26-tone DRUs 506 are denoted the child tones of the 52-tone DRU 502.

For example, the 52-tone DRU₁ 502A is split to two 26-tone DRUs 506A and 506B, the 52-tone DRU₂ 502B is split to two 26-tone DRUs 506C and 506D, the 52-tone DRU₄ 502C is split to two 26-tone DRUs 506E and 506F, and the 52-tone DRU₅ 502D is split to two 26-tone DRUs 506G and 506H.
Step 2: Combining a smaller-size DRU (which may be a child DRU split from a parent DRU such as a 26-tone DRU 506, or an original smaller-size DRU such as DRU₃ 504) with a non-parent larger-size DRU (such as a non-parent 52-tone DRU 502) to generate a 52+26-tone M-DRU. Herein, a non-parent 52-tone DRU 502 is a 52-tone DRU that the 26-tone DRU 506 is not split therefrom.

For example, as shown in FIG. 48A, the 26-tone DRU 506B may be combined with the 52-tone DRU 502B to form a 52+26-tone M-DRU 508A.

For example, as shown in FIG. 48B, the 26-tone DRU 506G may be combined with the 52-tone DRU 502C to form a 52+26-tone M-DRU 508B.

For example, as shown in FIG. 48C, the 26-tone DRU₃ 504 may be combined with the 52-tone DRU₂ 502B to form a 52+26-tone M-DRU 508C.

In some embodiment, the method illustrated in above-described 52+26-tone M-DRUs may be used for forming or otherwise generating M-DRUs in other DRU plans such as above-described DRU plans for OFDMA 40 MHz and 80 MHz PPDUs.

In some embodiment, the method illustrated in above-described 52+26-tone M-DRUs may be used for forming or otherwise generating M-DRUs of other size combinations.

For example, a 106+26-tone M-DRU in an OFDMA 20 MHz PPDU may be obtained based on the DRU plan shown in FIG. 30B having tow (2) 106-tone DRUs and one 26-tone DRU, and by combining one 106-tone DRU and one 26-tone DRU to form the M-DRU.

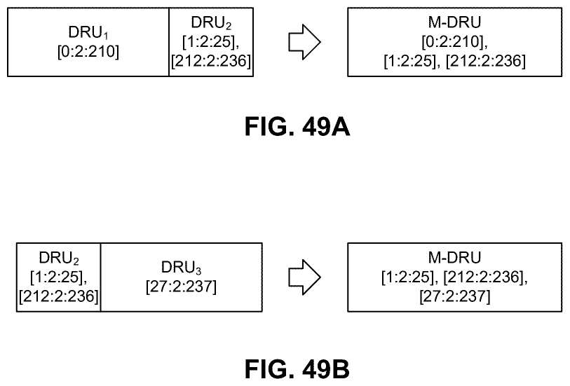

For example, as shown in FIG. 49A, the 106-tone DRU₁ may be combined with the 26-tone DRU₂ to form a 106+26-tone M-DRU.

For example, as shown in FIG. 49B, the 26-tone DRU₂ may be combined with the 106-tone DRU₃ to form a 106+26-tone M-DRU.

In some embodiments, the DRU-design methods may be used with a PPDU comprising unallocated or punctured portions of its bandwidth (wherein such portions would not be usable, at least temporarily, for transmitting data and/or pilot tones). As specified in 802.11be (35.15.2 Preamble puncturing operation, Draft IEEE P802.11be_D5.0), if a 20 MHz subchannel is a punctured, unassigned, or unallocated subchannel, the punctured 20 MHz subchannel shall not be used by any PPDU that is transmitted within the operating channel. The EHT AP shall use a triggering frame to solicit the response in a trigger-based (TB) PPDU and assign an RU or MRU within the set of non-punctured subchannels to a responding EHT STA.

Therefore, in a TB PPDU with a punctured subchannel, only a part of an operating channel, such as the effective operating channel, can be used for transmissions of RRU/MRU. Similarly, this requirement can also be applied to transmissions of DRU/M-DRU in a TB PPDU with puncturing.

In a TB PPDU with a punctured subchannel, the subcarriers of DRUs can only be distributed across the non-punctured subchannel set within an effective operating bandwidth rather than over the whole operating channel bandwidth. Tone separation in DRU is determined by the effective operating bandwidth.

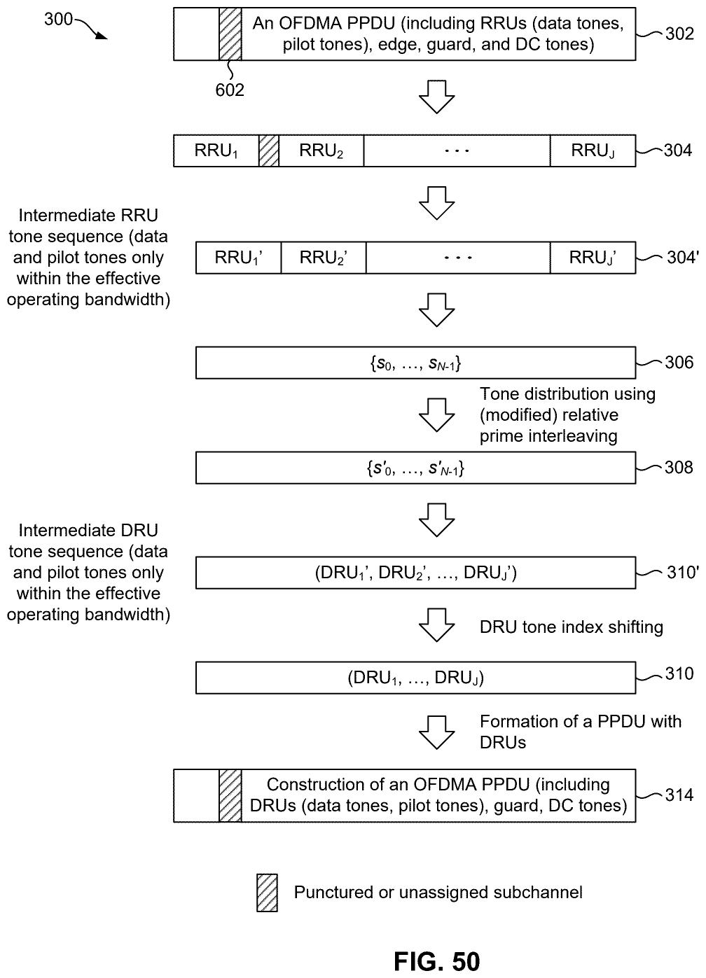

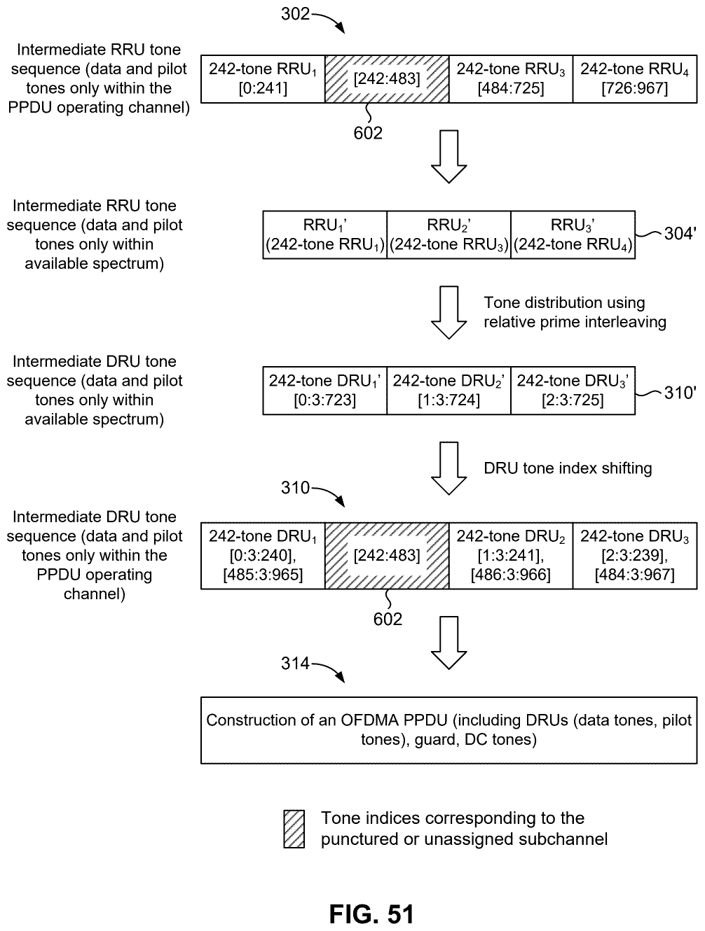

FIG. 50 is a flowchart showing the DRU-design procedure 300 with puncturing using (modified) relative prime interleaving, according to some embodiments of this disclosure. The DRU-design procedure 300 is similar to that shown in FIG. 11 except one additional step 602, DRU index shifting, is added due to the punctured subchannel(s) within the PPDU BW, which will be described in more detail below. FIG. 51 shows an example on tone distribution for three 242-tone DRUs in an 80 MHz TB PPDU, wherein the second 20 MHz subchannel 602 is punctured. As specified in Draft IEEE P802.11be_D5.0, any 20 MHz subchannel in an 80 MHz subblock can be punctured. The puncturing pattern in an 80 MHz subblock can be indicated in U-SIG in EHT. In a TB PPDU with a punctured subchannel, the subcarriers of DRUs can be distributed across the non-punctured subchannel set within an effective operating bandwidth.

As described above, the tones of an OFDMA PPDU may be classified as various types of tones based on the usage thereof, including usable tones (such as tones for transmitting data symbols (denoted “data tones”), tones for transmitting pilot symbols (denoted “pilot tones”), and/or the like) and unusable tones (such as edge tones, guard tones, DC tones, and/or the like).

Similar to the procedure described above, the indices of the usable tones are numbered sequentially as for example, 0, 1, 2, . . . , and the usable tones of the OFDMA PPDU 302 are partitioned into a plurality of RRUs 304. In the example shown in FIG. 51, the OFDMA PPDU 302 has 968 usable tones (data and pilot tones only) which are partitioned into four (4) 242-tone RRUs 304 (RRU₁ to RRU₄). The punctured subchannel corresponds to RRU₂ with indices from 242 to 483.

Then, the tones in the punctured subchannel of the OFDMA PPDU 302 are excluded to obtain an intermediate RRU tone sequence 304′ with the indices thereof being numbered consecutively, for example, as 0, 1, 2, . . . . In the example shown in FIG. 51, after excluding the tones in the punctured second 20 MHz subchannel 602 (that is, RRU₂), the intermediate 242-tone RRU tone sequence 304′ within the effective operating bandwidth has three RRUs with indices from 0 to 725 (including RRU₁′ to RRU₃′, corresponding to RRU₁, RRU₂, and RRU₄, respectively). The length of the intermediate 242-tone RRU tone sequence 304′ is 726 (=3×242). Following the same steps 306 and 308 of the procedure shown in FIG. 11, the relative prime interleaving is used to partition the intermediate RRU tone sequence 304′ into an intermediate DRU tone sequence 310′ having J DRUs, DRU₁′, . . . , DRU_{J}′.

In the example shown in FIG. 51, the relative prime interleaving with tone separation p=3 is used to partition the intermediate 242-tone RRU tone sequence 304′ of length 726 within the effective operating bandwidth into an intermediate 242-tone DRU tone sequence 310′ of length 726 having three 242-tone DRUs, including the 242-tone DRU₁′ with tone indices of [0:3:723], the 242-tone DRU₂′ with tone indices of [1:3:724], and the 242-tone DRU₃′ with tone indices of [2:3:725].

Then, the DRU design method checks if the indices of the intermediate DRU tone sequence 310′ fall within the indices of the excluded subchannel 602 in the usable tones 304.

In the example shown in FIG. 51, in the intermediate DRU tone sequence 310′, the tones with indices from 242 (which is the index of the first usable tone in the excluded subchannel 602) to 725 (which is the index of the last tone of the intermediate DRU tone sequence 310′) are right-shifted out of the index range 242 to 483 of the excluded subchannel 602 (for example, by adding 242 to the indices from 242 to 725 such that tone indices 242, 243, . . . , 725 in the intermediate DRU tone sequence 310′ become tone indices 484, 485, . . . , 967) to obtain the DRU tone sequence 310.

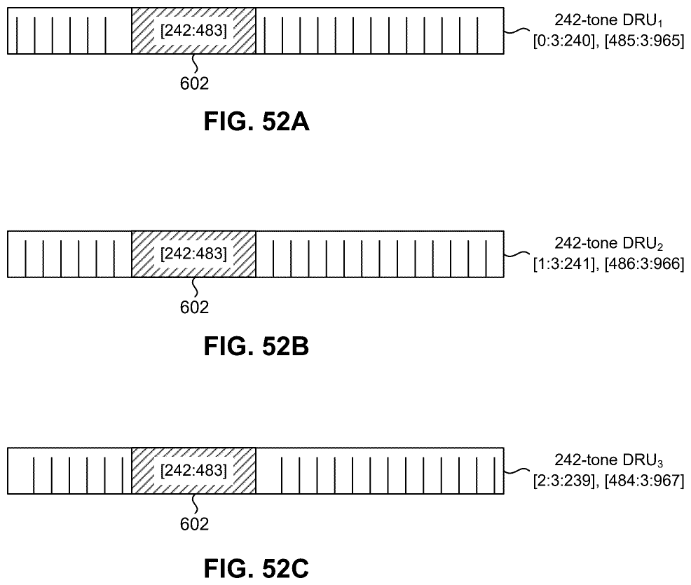

Note that, in FIG. 51, the DRUs in the DRU tone sequence 310 are shown side by side for ease of illustration. However, these DRUs are in fact distributed over the PPDU operating bandwidth. FIGS. 52A to 52C illustrate these DRUs separately, and the combination thereof is the DRU tone sequence 310. As clearly shown in FIGS. 52A to 52C, no subcarriers or tones are allocated to the tone indices [242:483] which correspond to the punctured 20 MHz subchannel.

Generally, in various embodiments, for each punctured subchannel, all subcarriers with tone indices in the effective operating bandwidth in the punctured subchannel, in addition to all other subcarriers with higher tone indices than the punctured subchannel, shall be shifted up in frequency by the bandwidth of the punctured subchannel plus the bandwidth of any other punctured subchannels into which they might otherwise be shifted. In a non-limiting example, in a 160 MHz PPDU with the second and fourth 20 MHz punctured, the subcarriers in the first 20 MHz remain unshifted, the subcarriers in the second 20 MHz are shifted into the third 20 MHz, the subcarriers in the third 20 MHz are shifted into the fifth 20 MHz (to avoid the also-punctured 4th 20 MHz), and subcarriers in the fourth to the sixth 20 MHz subchannels are all shifted up by 40 MHz.

In an example of DRU index shifting, a PPDU of bandwidth BWₜₒₜ contains a set Sₙ of non-punctured subcarriers and a set Uₓ of punctured subchannels, where n is an index of a non-punctured subcarrier in the PPDU, and x is an index of a punctured subchannel, assigned serially starting with one (1) irrespective of the position in the PPDU the punctured subcarrier occupies. Uₓ is the size in subcarriers of each punctured subchannel. Qₓ is the beginning index of each punctured subchannel. In the situation described by FIGS. 50, U₁=242, and Q₁=242. S₀ to S₂₄₁ and S₄₈₄ to S₉₆₇ are subcarriers belonging to RRUs scheduled for transmission.

It is advantageous in terms of simplicity to implement the prime interleaving process on a temporary contiguous set of subcarriers comprising only the non-punctured subcarriers, and it is built as follows. The subcarrier set Sₙ, before shuffling or interleaving, is compressed by moving into each index that is unoccupied by a punctured subchannel, the next available non-punctured subcarrier. In some embodiments, this can be accomplished by decrementing the index n of each subcarrier in Sₙ by an amount y(n), where y(n) is zero for all n<Q₁ (before any punctured subchannels are reached) and for all n which are subcarrier index Q₁ and greater (one or more punctured subchannels reached),

$$y ( n ) = {\sum }_{i = 1}^{x} {U}_{i}$$

where x is the greatest index of a punctured subchannel Qₓ such that Qₓ<=n. In other words, y(n) is the sum of the quantity of all subcarriers in punctured subchannels reached so far. If the first subchannel or more are punctured, y(n) will never be zero and all indices will be decremented. If there are punctured subchannels after the last scheduled RRU, n will never be greater than Qₓ for these punctured subchannels and they will not cause any index shifting.

After relative prime interleaving, the indices of S′ₖ are reverse shifted to reinsert the punctured subcarriers so that the PPDU can be transmitted with puncturing consistent with that signaled in its header. In an embodiment, this can be accomplished by incrementing the index k of each subcarrier in S′ₖ by the same amount previously subtracted y(k), where y(k) is zero for all k<Q₁ (before any punctured subchannels must be reinserted), and for all k which are subcarrier index Q₁ and greater (one or more punctured subchannels reached),

$$y ( k ) = {\sum }_{i = 1}^{x} {U}_{i}$$

where x is the greatest index of a punctured subchannel Qₓ such that Qₓ<=k. In other words, y(k) is the sum of the quantity of all subcarriers in punctured subchannels that are being skipped by the current index k.

In some embodiments, a DRU plan determined as described above may be stored in both an AP 102 and an STA 112 such as storing in one non-transitory computer-readable storage devices or media thereof as a DRU table. Then, the AP 102 and STA 112 may find a DRU for data and/or pilot transmission therebetween by looking up the DRU table.

In some embodiments, instead of using a DRU table, the AP 102 and STA 112 may calculate the DRU plan as described above, and select a DRU from the calculated DRU plan for data and/or pilot transmission therebetween without looking up a DRU table.

Thus, the DRU-design methods disclosed herein are systematic methods to distribute subcarriers (that is, tones) in multiple RUs, each of which is for a specific STA, in an OFDMA PPDU by using relative prime interleaving to ensure the tones within each RU for different RU sizes and a variety of PPDU bandwidths to be substantially uniformly (that is, uniformly or nearly uniformly) distributed in order to avoid potential tone transmit power imbalance and significant different tone separations within one DRU and across DRUs. Existing 802.11ax/be RU locations and tone plan can be reused. The DRUs and their arrangements provide improved communication performance while meeting the government-regulated PSD requirements.

By using a (modified) relative prime interleaver, the DRU design methods disclosed herein provides ease of implementation and the flexibility that the indices in the interleaving/deinterleaving can be generated “on-the-fly” instead of using index mapping tables. This reduces the storage and memory in systems.

The DRU-design methods disclosed herein and the resulting DRU plans may be related to the standardization of next generation of IEEE 802.11be for operation on the unlicensed millimeter bands.

The DRU-design methods disclosed herein and the resulting DRU plans may be used in WI-FI APs and STAs with operating capability in both sub-7 GHz and millimeter bands.

### C. Acronym Key

| Full Name | Acronym/Abbreviation/Initialism |
|---|---|
| Access point | AP |
| Bandwidth | BW |
| Equivalent isotropic radiated power | EIRP |
| Local Area Network | LAN |
| Medium Access Control Layer | MAC |
| Orthogonal frequency division | OFDMA |
| multiplexing access | |
| Power spectral density | PSD |
| Stations | STAs |
| Wireless LAN | WLAN |

Those skilled in the art will appreciate that, in some embodiments, the methods disclosed herein may be implemented as one or more circuits of a module, a device, an apparatus, a system, and/or the like. In some embodiments, the methods disclosed herein may be implemented as computer-executable instructions stored in one or more non-transitory computer-readable storage devices such that, the instructions, when executed, may cause one or more circuits to perform the methods disclosed herein.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
transmitting or receiving a signal using a first resource unit (RU) in an orthogonal frequency-division multiple access (OFDMA) physical layer protocol data unit (PPDU) having a plurality of subcarriers for transmitting data, pilot symbols, or a combination thereof;
wherein a subset of the subcarriers are unavailable for use, thereby giving rise to a plurality of available subcarriers being the plurality of subcarriers excluding the subset of unavailable subcarriers;
wherein the first RU is one of a plurality of RUs of the OFDMA PPDU;
wherein each RU comprises a subset of the plurality of available subcarriers;
wherein the subcarrier indices of any one of the plurality of RUs are different from the subcarrier indices of any other one of the plurality of RUs; and the subcarriers of each of the plurality of RUs are substantially distributed over an entirety of a frequency spectrum formed by all the available subcarriers; and
wherein the subset of unavailable subcarriers comprises a plurality of predefined unavailable subcarriers and a plurality of unavailable subcarriers in an unallocated or punctured frequency spectrum.

2. The communication method of claim 1, wherein the subcarriers of each RU are same as those determined in accordance with a design method that shuffles the plurality of subcarriers; and
wherein the design method comprises:
indexing the plurality of subcarriers to obtain an initial sequence comprising a plurality of consecutive first indices, the first indices comprising one or more index ranges corresponding to the unavailable subcarriers,
indexing available subcarriers to obtain a first sequence comprising a plurality of consecutive second indices from a first end index to a second end index, the available subcarriers being the plurality of subcarriers excluding the subset of unavailable subcarriers,
shuffling the first sequence to obtain a second sequence,
comparing the second sequence with the initial sequence to determine if any of the second indices fall within the one or more index ranges, and if any of the second indices fall within the one or more index ranges, updating the second sequence such that no second indices fall within the one or more index ranges, and
determining the plurality of RUs based on a partitioning of the second sequence that partitions the second sequence into a plurality of consecutive blocks, each block corresponding to a respective one of the plurality of RUs.

3. The communication method of claim 2, wherein said updating the second sequence comprises:
for each of the one or more index ranges that one or more of the second indices fall therewithin, updating the second sequence by adjusting, using a value, the indices from the one or more of the second indices to a predefined one of the first and second end indices, such that, after said updating the second sequence, no second indices fall within the one or more index ranges.

4. The communication method of claim 2, wherein said updating the second sequence comprises:
for each of the one or more index ranges that one or more of the second indices fall therewithin, updating the second sequence by adding a respective value to the indices from the one or more of the second indices to a larger one of the first and second end indices, such that, after said updating the second sequence, no second indices fall within the one or more index ranges.

5. The communication method of claim 2, wherein said shuffling the first sequence to obtain the second sequence comprises:
shuffling the first sequence to obtain the second sequence using a relative prime interleaving method.

6. The communication method of claim 5, wherein said shuffling the first sequence to obtain the second sequence using the relative prime interleaving method comprises:
shuffling the first sequence {sₙ} to obtain the second sequence {sₖ′=sₖ₍ₙ₎}, where n=0, . . . , N−1 is an index of the first sequence, N is a length of the first sequence,
$$k ( n ) = ( p \cdot n ) mod N$$
for n=0, . . . , N−1, k is an index of the second sequence and is a function of n, mod represents a modulo function, and p is a distance between two neighboring subcarriers in each RU and is a relative prime of N such that p and N have no common factors other than one.

7. An apparatus comprising:
at least one processor; and
one or more non-transitory computer-readable storage media functionally coupled to the at least one processor;
wherein the one or more non-transitory computer-readable storage media comprising computer-executable instructions, wherein the instructions, when executed, cause the at least one processor to perform actions comprising:
transmitting or receiving a signal using a first resource unit (RU) in an orthogonal frequency-division multiple access (OFDMA) physical layer protocol data unit (PPDU) having a plurality of subcarriers for transmitting data, pilot symbols, or a combination thereof;
wherein a subset of the subcarriers are unavailable for use, thereby giving rise to a plurality of available subcarriers being the plurality of subcarriers excluding the subset of unavailable subcarriers;
wherein the first RU is one of a plurality of RUs of the OFDMA PPDU;
wherein each RU comprises a subset of the plurality of available subcarriers;
wherein the subcarrier indices of any one of the plurality of RUs are different from the subcarrier indices of any other one of the plurality of RUs; and the subcarriers of each of the plurality of RUs are substantially distributed over an entirety of a frequency spectrum formed by all the available subcarriers; and
wherein the subset of unavailable subcarriers comprises a plurality of predefined unavailable subcarriers and a plurality of unavailable subcarriers in an unallocated or punctured frequency spectrum.

8. The apparatus of claim 7, wherein the subcarriers of each RU are same as those determined in accordance with a design method that shuffles the plurality of subcarriers; and
wherein the design method comprises:
indexing the plurality of subcarriers to obtain an initial sequence comprising a plurality of consecutive first indices, the first indices comprising one or more index ranges corresponding to the unavailable subcarriers,
indexing available subcarriers to obtain a first sequence comprising a plurality of consecutive second indices from a first end index to a second end index, the available subcarriers being the plurality of subcarriers excluding the subset of unavailable subcarriers,
shuffling the first sequence to obtain a second sequence,
comparing the second sequence with the initial sequence to determine if any of the second indices fall within the one or more index ranges, and if any of the second indices fall within one the one or more index ranges, updating the second sequence such that no second indices fall within the one or more index ranges, and
determining the plurality of RUs based on a partitioning of the second sequence that partitions the second sequence into a plurality of consecutive blocks, each block corresponding to a respective one of the plurality of RUs.

9. The apparatus of claim 8, wherein said updating the second sequence comprises:
for each of the one or more index ranges that one or more of the second indices fall therewithin, updating the second sequence by adjusting, using a value, the indices from the one or more of the second indices to a predefined one of the first and second end indices, such that, after said updating the second sequence, no second indices fall within the one or more index ranges.

10. The apparatus of claim 8, wherein said updating the second sequence comprises:
for each of the one or more index ranges that one or more of the second indices fall therewithin, updating the second sequence by adding a respective value to the indices from the one or more of the second indices to a larger one of the first and second end indices, such that, after said updating the second sequence, no second indices fall within the one or more index ranges.

11. The apparatus of claim 8, wherein said shuffling the first sequence to obtain the second sequence comprises:
shuffling the first sequence to obtain the second sequence using a relative prime interleaving method.

12. The apparatus of claim 11, wherein said shuffling the first sequence to obtain the second sequence using the relative prime interleaving method comprises:
shuffling the first sequence {sₙ} to obtain the second sequence {sₖ′=sₖ₍ₙ₎}, where n=0, . . . , N−1 is an index of the first sequence, N is a length of the first sequence,
$$k ( n ) = ( p \cdot n ) mod N$$
for n=0, . . . , N−1, k is an index of the second sequence and is a function of n, mod represents a modulo function, and p is a distance between two neighboring subcarriers in each RU and is a relative prime of N such that p and N have no common factors other than one.

13. The apparatus of claim 12, wherein p·max(Nⱼ)<N for j=1, . . . , J, where Nⱼ is a number of the subcarriers of the j-th RU, J is a number of the plurality of RUs, and max( ) represents a maximum function.

14. One or more non-transitory computer-readable storage media comprising computer-executable instructions, wherein the instructions, when executed, cause one or more circuits to perform actions comprising:
transmitting or receiving a signal using a first resource unit (RU) in an orthogonal frequency-division multiple access (OFDMA) physical layer protocol data unit (PPDU) having a plurality of subcarriers for transmitting data, pilot symbols, or a combination thereof;
wherein a subset of the subcarriers are unavailable for use, thereby giving rise to a plurality of available subcarriers being the plurality of subcarriers excluding the subset of unavailable subcarriers;
wherein the first RU is one of a plurality of RUs of the OFDMA PPDU;
wherein each RU comprises a subset of the plurality of available subcarriers;
wherein the subcarrier indices of any one of the plurality of RUs are different from the subcarrier indices of any other one of the plurality of RUs; and the subcarriers of each of the plurality of RUs are substantially distributed over an entirety of a frequency spectrum formed by all the available subcarriers; and
wherein the subset of unavailable subcarriers comprise a plurality of predefined unavailable subcarriers and a plurality of unavailable subcarriers in an unallocated or punctured frequency spectrum.

15. The one or more non-transitory computer-readable storage media of claim 14, wherein the subcarriers of each RU are same as those determined in accordance with a design method that shuffles the plurality of subcarriers; and
wherein the design method comprises:
indexing the plurality of subcarriers to obtain an initial sequence comprising a plurality of consecutive first indices, the first indices comprising one or more index ranges corresponding to the unavailable subcarriers,
indexing available subcarriers to obtain a first sequence comprising a plurality of consecutive second indices from a first end index to a second end index, the available subcarriers being the plurality of subcarriers excluding the subset of unavailable subcarriers,
shuffling the first sequence to obtain a second sequence,
comparing the second sequence with the initial sequence to determine if any of the second indices fall within the one or more index ranges, and if any of the second indices fall within one the one or more index ranges, updating the second sequence such that no second indices fall within the one or more index ranges, and
determining the plurality of RUs based on a partitioning of the second sequence that partitions the second sequence into a plurality of consecutive blocks, each block corresponding to a respective one of the plurality of RUs.

16. The one or more non-transitory computer-readable storage media of claim 15, wherein said updating the second sequence comprises:
for each of the one or more index ranges that one or more of the second indices fall therewithin, updating the second sequence by adjusting, using a value, the indices from the one or more of the second indices to a predefined one of the first and second end indices, such that, after said updating the second sequence, no second indices fall within the one or more index ranges.

17. The one or more non-transitory computer-readable storage media of claim 15, wherein said updating the second sequence comprises:
for each of the one or more index ranges that one or more of the second indices fall therewithin, updating the second sequence by adding a respective value to the indices from the one or more of the second indices to a larger one of the first and second end indices, such that, after said updating the second sequence, no second indices fall within the one or more index ranges.

18. The one or more non-transitory computer-readable storage media of claim 15, wherein said shuffling the first sequence to obtain the second sequence comprises:
shuffling the first sequence to obtain the second sequence using a relative prime interleaving method.

19. The one or more non-transitory computer-readable storage media of claim 18, wherein said shuffling the first sequence to obtain the second sequence using the relative prime interleaving method comprises:
shuffling the first sequence {sₙ} to obtain the second sequence {sₖ′=sₖ₍ₙ₎}, where n=0, . . . , N−1 is an index of the first sequence, N is a length of the first sequence,
$$k ( n ) = ( p \cdot n ) mod N$$
for n=0, . . . , N−1, k is an index of the second sequence and is a function of n, mod represents a modulo function, and p is a distance between two neighboring subcarriers in each RU and is a relative prime of N such that p and N have no common factors other than one.

20. The one or more non-transitory computer-readable storage media of claim 19, wherein p·max(Nⱼ)<N for j=1, . . . , J, where Nⱼ is a number of the subcarriers of the j-th RU, J is a number of the plurality of RUs, and max( ) represents a maximum function.
